(19) United States
(12) Patent Application Publication
(10) Pub. No.: US 2025/0100348 A1
(43) Pub. Date: Mar. 27, 2025

(54) METHOD FOR MITIGATING DRIVER DISTRACTION

(71) Applicant: Mitsubishi Electric Automotive America, Inc., Mason, OH (US)

(72) Inventors: Sana JAFRI, Northville, MI (US); John DERKACZ, Northville, MI (US); Michael Deen HORANI, Northville, MI (US)

(21) Appl. No.: 18/471,684

(22) Filed: Sep. 21, 2023

(51) Int. Cl. B60H 1/00

(52) U.S. Cl. CPC B60H 1/00985

(57) ABSTRACT

A method of mitigating driver distraction in a vehicle is provided that includes enabling a first mode in which a first plurality of vehicle features can be controlled; monitoring an interior of the vehicle using vehicle sensors; gathering sensor data from the vehicle sensors; estimating a cognitive load of the driver based on the sensor data; determining that the cognitive load of the driver exceeds a cognitive load threshold; and disabling the first mode and enabling a focus mode in response to determining that the cognitive load of the driver exceeds the cognitive load threshold, the focus mode disabling one or more vehicle features from the first plurality of vehicle features and enabling a second plurality of vehicle features to be controlled, the second plurality of vehicle features being a subset of the first plurality of vehicle features that is smaller in number than the first plurality of vehicle features.

### TECHNICAL FIELD

The disclosed methods relate generally to methods used in a vehicle to mitigate driver distraction. More particularly, the disclosed methods relate to ways to monitor sensor data to identify whether there is a likelihood that a driver is distracted and then take actions to try and minimize or eliminate the driver's distraction.

### BACKGROUND

As vehicles become more complicated with more features, the opportunities for driver distraction increase. When this is added to the existing potential distractions, such as drowsiness, emotional response, distraction from people or items inside the vehicle, the potential for driver distraction rises even more. Driver distraction can lead to driver error, which can result in an accident that may cause injury to the driver, a passenger, an adjacent motorist, or a pedestrian and may result in damage to the driven vehicle or an adjacent vehicle.

Various techniques exist to identify individual distraction events, such as drowsiness, distraction from the road, or distraction based on events inside the vehicle. However, such individual techniques are isolated in what they identify. They do not provide an adequate overall assessment of a driver's total distraction, nor do they necessarily provide robust ways in which that distraction can be mitigated.

It is therefore desirable to provide a driver distraction mitigation system and method that identifies multiple types of driver distraction, assesses them individually and in the collective, and takes action and provides recommendations to the driver to mitigate the identified distraction. It is further desirable that the driver distraction mitigation system and method fit the needs of individual drivers such that it will both be appreciated by the drivers and followed by them.

### SUMMARY OF THE INVENTION

According to one or more embodiments, a computer-implemented method of mitigating driver distraction in a vehicle is provided, the method including: enabling a first mode in which a first plurality of vehicle features are configured to be controllable by a driver or passenger; monitoring an interior of the vehicle using a plurality of vehicle sensors; gathering vehicle sensor data from the plurality of vehicle sensors; estimating a cognitive load of the driver based on the vehicle sensor data; determining that the cognitive load of the driver exceeds a cognitive load threshold; and disabling the first mode and enabling a focus mode in response to determining that the cognitive load of the driver exceeds a cognitive load threshold, the focus mode disabling one or more vehicle features from the first plurality of vehicle features and enabling a second plurality of vehicle features to be controlled by the driver or passenger, the second plurality of vehicle features being a subset of the first plurality of vehicle features that is smaller in number than the first plurality of vehicle features.

The plurality of vehicle sensors may include at least one of camera sensors and audio sensors, and at least one of thermal sensors, radar sensors, and wearable biometric sensors.

The estimating of the cognitive load of the driver based on the vehicle sensor data may further include: gathering first sensor data from a first vehicle sensor; gathering second sensor data from a second vehicle sensor; calculating a first estimated cognitive load based on the first sensor data; and calculating a second estimated cognitive load based on the second sensor data.

The determining that the cognitive load of the driver exceeds the cognitive load threshold may further include: determining that the first estimated cognitive load exceeds a first cognitive load threshold; determining that the second estimated cognitive load does not exceed a second cognitive load threshold; and determining that the cognitive load of the driver exceeds the cognitive load threshold based on the determination that the first estimated cognitive load exceeds the first cognitive load threshold.

The determining that the cognitive load of the driver exceeds the cognitive load threshold may further include: calculating a combined estimated cognitive load based on both the first estimated cognitive load and the second estimated cognitive load; and determining that the combined estimated cognitive load exceeds a combined cognitive load threshold; and determining that the cognitive load of the driver exceeds the cognitive load threshold based on the determination that the combined estimated cognitive load exceeds the combined cognitive load threshold.

In calculating the combined estimated cognitive load based on both the first estimated cognitive load and the second estimated cognitive load, the first estimated cognitive load and the second estimated cognitive load may be given different weights.

The first sensor data may be first driver sensor data indicative of a first characteristic of the driver, and the second sensor data may be second driver sensor data indicative of a second characteristic of the driver.

The first sensor data may be driver sensor data indicative of a characteristic of the driver, and the second sensor data may be environment sensor data indicative of an environmental characteristic of an interior of the vehicle.

The characteristic of the driver may include at least one of an estimated drowsiness of the driver, an estimated emotional state of the driver, an estimated attentiveness of the driver to a road in front of the vehicle, and an amount of time the driver is interacting with a human-machine interface.

The characteristic of the interior of the vehicle may include at least one of a sound level within the interior of the vehicle, a light level within the interior of the vehicle, a level of passenger movement within the interior of the vehicle, and an estimated level of passenger interaction with the driver.

The first plurality of vehicle features may include heating, ventilation, and cooling (HVAC) control and navigation control, and at least two of radio/media control, lighting control, streaming video control, streaming gaming control, weather data access, calendar data access and control, and mobile telephone control, and the second plurality of vehicle features may include heating, ventilation, and cooling (HVAC) control and navigation control, and at least one of radio control, lighting control, streaming video control, streaming gaming control, weather data, calendar data, and mobile telephone control.

The plurality of vehicle sensors may include one or more audio sensors configured to gather audio data indicative of noise in a cabin of the vehicle, the vehicle sensor data may include the audio data, and the estimating of the cognitive load of the driver based on the vehicle sensor data may further include determining if the noise level in the cabin of the vehicle is higher than an upper threshold decibel level based on the audio data; determining if the noise level in the cabin of the vehicle is lower than a lower threshold decibel level based on the audio data; increasing a distraction level when it is determined that the noise level in the cabin of the vehicle is higher than the upper threshold decibel level, decreasing the distraction level when it is determined that the noise level in the cabin of the vehicle is lower than the lower threshold decibel level, determining the cognitive load of the driver based on the distraction level.

The operations of determining if the noise level in the cabin of the vehicle is higher than an upper threshold decibel level, determining if the noise level in the cabin of the vehicle is lower than a lower threshold decibel level, increasing a distraction level when it is determined that the noise level in the cabin of the vehicle is higher than the upper threshold decibel level, decreasing the distraction level when it is determined that the noise level in the cabin of the vehicle is lower than the lower threshold decibel level, and determining the cognitive load of the driver based on the distraction level may be repeated over time.

The plurality of vehicle sensors may include one or more camera sensors configured to gather video data relating to the driver, the video data being indicative of the driver being in one of at least one emotional state, the at least one emotional state may include at least one of anger, joy, and surprise, the at least one emotional state each area may be associated with an emotional confidence modifier, the vehicle sensor data includes the video data, and the estimating of the cognitive load of the driver based on the vehicle sensor data may further include determining whether the driver is in one of the at least one emotional state based on the video data, determining that the driver is in a detected emotional state selected from the at least one emotional state based on the video data when it is determined that the driver is in one of the at least one emotional state, modifying an emotional confidence value by the emotional confidence modifier associated with the detected emotional state, and estimating the cognitive load of the driver based on the emotional confidence value.

The operations of determining whether the driver is in one of the plurality of emotional states, determining that the driver is in a detected emotional state, modifying an emotional confidence value by the emotional confidence modifier associated with the detected emotional state, and estimating the cognitive load of the driver based on the emotional confidence value may be repeated over time.

The plurality of vehicle sensors may include one or more camera sensors configured to gather video data relating to the driver, the video data being indicative of whether a gaze of the driver is distracted from a road ahead of the vehicle, the vehicle sensor data includes the video data, and the estimating of the cognitive load of the driver based on the vehicle sensor data may further include determining whether the gaze of the driver is distracted from the road based on the video data, increasing a current distraction level when it is determined that the gaze of the driver is distracted from the road, decreasing the current distraction level when it is determined that the gaze of the driver is not distracted from the road, and estimating the cognitive load of the driver based on the current distraction level.

The operations of determining whether the gaze of the driver is distracted from the road, increasing a current distraction level when it is determined that the gaze of the driver is distracted from the road, decreasing the current distraction level when it is determined that the gaze of the driver is not distracted from the road, and estimating the cognitive load of the driver based on the current distraction level may be repeated over time.

The plurality of vehicle sensors may include one or more camera sensors configured to gather video data relating to the driver, the video data being indicative of whether the driver is drowsy, the vehicle sensor data may include the video data, and the estimating of the cognitive load of the driver based on the vehicle sensor data may further include determining whether the driver is drowsy based on the video data, increasing a current distraction level when it is determined that the driver is drowsy, decreasing the current distraction level when it is determined that the driver is not drowsy, and estimating the cognitive load of the driver based on the current distraction level.

The operations of determining whether the driver is drowsy, increasing a current distraction level when it is determined that the driver is drowsy, decreasing the current distraction level when it is determined that the driver is not drowsy, and estimating the cognitive load of the driver based on the current distraction level may be repeated over time.

The plurality of vehicle sensors may include a human-machine interface (HMI) configured to gather HMI data indicative of how many times the driver interacts with the HMI during a set time period, the vehicle sensor data may include the HMI data, and the estimating of the cognitive load of the driver based on the vehicle sensor data may further include determining whether the driver has interacted with the HMI during the set time period based on the HMI data, increasing a current distraction level when it is determined that the driver has interacted with the HMI during the set time period, decreasing the current distraction level when it is determined that the driver has not interacted with the HMI during the set time period, and estimating the cognitive load of the driver based on the current distraction level.

The operations of determining whether the driver has interacted with the HMI during the set time period, increasing a current distraction level when it is determined that the driver has interacted with the HMI during the set time period, decreasing the current distraction level when it is determined that the driver has not interacted with the HMI during the set time period, and estimating the cognitive load of the driver based on the current distraction level may be repeated over time.

The subset of the first plurality of vehicle features that forms the second plurality of vehicle features are configured to be modifiable based on previous vehicle sensor data from the plurality of vehicle sensors and related determinations regarding a driver status of the driver and an environmental status of the interior of the vehicle.

The subset of the first plurality of vehicle features that forms the second plurality of vehicle features may be configured to be modifiable based on input from the driver.

A selection of the plurality of vehicle sensors from a number of available vehicle sensors may be configured to be modifiable based on input from the driver.

A selection of possible distractions monitored by the plurality of vehicle sensors may be configured to be modifiable based on input from the driver.

The method of mitigating driver distraction in the vehicle may further include identifying one or more mitigating activities in response to determining that the cognitive load of the driver exceeds the cognitive load threshold, the one or more mitigating activities being predicted to reduce distraction of the driver; announcing the one or more mitigating activities to the driver.

The one or more mitigating activities may include one or more of suggesting stopping the vehicle at a nearby location, changing ambient light in the vehicle interior, and playing specific audio inside the vehicle interior.

The operation of determining that the cognitive load of the driver exceeds the cognitive load threshold may further include: receiving a voice command from the driver indicating that the cognitive load of the driver exceeds the cognitive load threshold.

A non-transitory computer-readable medium is provided, comprising instructions for execution by a computer, the instructions including a computer-implemented method for mitigating driver distraction in a vehicle, the instructions for implementing: enabling a first mode in which a first plurality of vehicle features are configured to be controllable by a driver or passenger; monitoring an interior of the vehicle using a plurality of vehicle sensors; gathering vehicle sensor data from the plurality of vehicle sensors; estimating a cognitive load of the driver based on the vehicle sensor data; determining that the cognitive load of the driver exceeds a cognitive load threshold; and disabling the first mode and enabling a focus mode in response to determining that the cognitive load of the driver exceeds a cognitive load threshold, the focus mode disabling one or more vehicle features from the first plurality of vehicle features and enabling a second plurality of vehicle features to be controlled by the driver or passenger, the second plurality of vehicle features being a subset of the first plurality of vehicle features that is smaller in number than the first plurality of vehicle features.

The plurality of vehicle sensors may include at least one of camera sensors and audio sensors, and at least one of thermal sensors, radar sensors, and wearable biometric sensors.

The estimating of the cognitive load of the driver based on the vehicle sensor data may further include: gathering first sensor data from a first vehicle sensor;
gathering second sensor data from a second vehicle sensor; calculating a first estimated cognitive load based on the first sensor data; and calculating a second estimated cognitive load based on the second sensor data.

The determining that the cognitive load of the driver exceeds the cognitive load threshold may further include: determining that the first estimated cognitive load exceeds a first cognitive load threshold; determining that the second estimated cognitive load does not exceed a second cognitive load threshold; and determining that the cognitive load of the driver exceeds the cognitive load threshold based on the determination that the first estimated cognitive load exceeds the first cognitive load threshold.

The determining that the cognitive load of the driver exceeds the cognitive load threshold may further include: calculating a combined estimated cognitive load based on both the first estimated cognitive load and the second estimated cognitive load; and determining that the combined estimated cognitive load exceeds a combined cognitive load threshold; and determining that the cognitive load of the driver exceeds the cognitive load threshold based on the determination that the combined estimated cognitive load exceeds the combined cognitive load threshold.

In calculating the combined estimated cognitive load based on both the first estimated cognitive load and the second estimated cognitive load, the first estimated cognitive load and the second estimated cognitive load may be given different weights.

The first sensor data may be first driver sensor data indicative of a first characteristic of the driver, and the second sensor data may be second driver sensor data indicative of a second characteristic of the driver.

The first sensor data may be driver sensor data indicative of a characteristic of the driver, and the second sensor data may be environment sensor data indicative of an environmental characteristic of an interior of the vehicle.

The characteristic of the driver may include at least one of an estimated drowsiness of the driver, an estimated emotional state of the driver, an estimated attentiveness of the driver to a road in front of the vehicle, and an amount of time the driver is interacting with a human-machine interface.

The characteristic of the interior of the vehicle may include at least one of a sound level within the interior of the vehicle, a light level within the interior of the vehicle, a level of passenger movement within the interior of the vehicle, and an estimated level of passenger interaction with the driver.

The first plurality of vehicle features may include heating, ventilation, and cooling (HVAC) control and navigation control, and at least two of radio/media control, lighting control, streaming video control, streaming gaming control, weather data access, calendar data access and control, and mobile telephone control, and the second plurality of vehicle features may include heating, ventilation, and cooling (HVAC) control and navigation control, and at least one of radio control, lighting control, streaming video control, streaming gaming control, weather data, calendar data, and mobile telephone control.

The plurality of vehicle sensors may includes one or more audio sensors configured to gather audio data indicative of noise in a cabin of the vehicle, the vehicle sensor data may include the audio data, and the estimating of the cognitive load of the driver based on the vehicle sensor data may further includes determining if the noise level in the cabin of the vehicle is higher than an upper threshold decibel level based on the audio data, determining if the noise level in the cabin of the vehicle is lower than a lower threshold decibel level based on the audio data, increasing a distraction level when it is determined that the noise level in the cabin of the vehicle is higher than the upper threshold decibel level, decreasing the distraction level when it is determined that the noise level in the cabin of the vehicle is lower than the lower threshold decibel level, and determining the cognitive load of the driver based on the distraction level.

The operations of determining if the noise level in the cabin of the vehicle is higher than an upper threshold decibel level, determining if the noise level in the cabin of the vehicle is lower than a lower threshold decibel level, increasing a distraction level when it is determined that the noise level in the cabin of the vehicle is higher than the upper threshold decibel level, decreasing the distraction level when it is determined that the noise level in the cabin of the vehicle is lower than the lower threshold decibel level, and determining the cognitive load of the driver based on the distraction level may be repeated over time.

The plurality of vehicle sensors may include one or more camera sensors configured to gather video data relating to the driver, the video data being indicative of the driver being in one of at least one emotional state, the at least one emotional state may include at least one of anger, joy, and surprise, the at least one emotional state may each be associated with an emotional confidence modifier, the vehicle sensor data includes the video data, and the estimating of the cognitive load of the driver based on the vehicle sensor data may further include determining whether the driver is in one of the at least one emotional state based on the video data, determining that the driver is in a detected emotional state selected from the at least one emotional state based on the video data when it is determined that the driver is in one of the at least one emotional state, modifying an emotional confidence value by the emotional confidence modifier associated with the detected emotional state, and estimating the cognitive load of the driver based on the emotional confidence value.

The operations of determining whether the driver is in one of the plurality of emotional states, determining that the driver is in a detected emotional state, modifying an emotional confidence value by the emotional confidence modifier associated with the detected emotional state, and estimating the cognitive load of the driver based on the emotional confidence value may be repeated over time.

The plurality of vehicle sensors may include one or more camera sensors configured to gather video data relating to the driver, the video data being indicative of whether a gaze of the driver is distracted from a road ahead of the vehicle,

the vehicle sensor data may include the video data, and the estimating of the cognitive load of the driver based on the vehicle sensor data may further include determining whether the gaze of the driver is distracted from the road based on the video data, increasing a current distraction level when it is determined that the gaze of the driver is distracted from the road, decreasing the current distraction level when it is determined that the gaze of the driver is not distracted from the road, and estimating the cognitive load of the driver based on the current distraction level.

The operations of determining whether the gaze of the driver is distracted from the road, increasing a current distraction level when it is determined that the gaze of the driver is distracted from the road, decreasing the current distraction level when it is determined that the gaze of the driver is not distracted from the road, and estimating the cognitive load of the driver based on the current distraction level may be repeated over time.

The plurality of vehicle sensors may include one or more camera sensors configured to gather video data relating to the driver, the video data being indicative of whether the driver is drowsy, the vehicle sensor data may include the video data, and the estimating of the cognitive load of the driver based on the vehicle sensor data may further include determining whether the driver is drowsy based on the video data, increasing a current distraction level when it is determined that the driver is drowsy, decreasing the current distraction level when it is determined that the driver is not drowsy, and estimating the cognitive load of the driver based on the current distraction level.

The operations of determining whether the driver is drowsy, increasing a current distraction level when it is determined that the driver is drowsy, decreasing the current distraction level when it is determined that the driver is not drowsy, and estimating the cognitive load of the driver based on the current distraction level may be repeated over time.

The plurality of vehicle sensors may include a human-machine interface (HMI) configured to gather HMI data indicative of how many times the driver interacts with the HMI during a set time period, the vehicle sensor data may include the HMI data, and the estimating of the cognitive load of the driver based on the vehicle sensor data may further include determining whether the driver has interacted with the HMI during the set time period based on the HMI data, increasing a current distraction level when it is determined that the driver has interacted with the HMI during the set time period, decreasing the current distraction level when it is determined that the driver has not interacted with the HMI during the set time period, and estimating the cognitive load of the driver based on the current distraction level.

The operations of determining whether the driver has interacted with the HMI during the set time period, increasing a current distraction level when it is determined that the driver has interacted with the HMI during the set time period, decreasing the current distraction level when it is determined that the driver has not interacted with the HMI during the set time period, and estimating the cognitive load of the driver based on the current distraction level may be repeated over time.

The subset of the first plurality of vehicle features that forms the second plurality of vehicle features may be configured to be modifiable based on previous vehicle sensor data from the plurality of vehicle sensors and related determinations regarding a driver status of the driver and an environmental status of the interior of the vehicle.

The subset of the first plurality of vehicle features that forms the second plurality of vehicle features may be configured to be modifiable based on input from the driver.

A selection of the plurality of vehicle sensors from a number of available vehicle sensors may be configured to be modifiable based on input from the driver.

A selection of possible distractions monitored by the plurality of vehicle sensors may be configured to be modifiable based on input from the driver.

The non-transitory computer-readable medium in which the instructions may be for further implementing identifying one or more mitigating activities in response to determining that the cognitive load of the driver exceeds the cognitive load threshold, the one or more mitigating activities being predicted to reduce distraction of the driver; and announcing the one or more mitigating activities to the driver.

The one or more mitigating activities may include one or more of suggesting stopping the vehicle at a nearby location, changing ambient light in the vehicle interior, and playing specific audio inside the vehicle interior.

The operation of determining that the cognitive load of the driver exceeds the cognitive load threshold may further include: receiving a voice command from the driver indicating that the cognitive load of the driver exceeds the cognitive load threshold.

A computer system may be provided that is configured for controlling an operational mode of an outdoor air-conditioning unit connected to a plurality of indoor air-conditioning units, the plurality of indoor air-conditioning units including a master indoor unit and a plurality of reporting indoor units, the system including: a transceiver operable to transmit and receive communications over at least a portion of a network; a memory configured to store data and instructions; and a processor cooperatively operable with the transceiver and the memory, and configured to facilitate: enabling a first mode in which a first plurality of vehicle features are configured to be controllable by a driver or passenger; monitoring an interior of the vehicle using a plurality of vehicle sensors; gathering vehicle sensor data from the plurality of vehicle sensors; estimating a cognitive load of the driver based on the vehicle sensor data; determining that the cognitive load of the driver exceeds a cognitive load threshold; and disabling the first mode and enabling a focus mode in response to determining that the cognitive load of the driver exceeds a cognitive load threshold, the focus mode disabling one or more vehicle features from the first plurality of vehicle features and enabling a second plurality of vehicle features to be controlled by the driver or passenger, the second plurality of vehicle features being a subset of the first plurality of vehicle features that is smaller in number than the first plurality of vehicle features.

The plurality of vehicle sensors may include at least one of camera sensors and audio sensors, and at least one of thermal sensors, radar sensors, and wearable biometric sensors.

The estimating of the cognitive load of the driver based on the vehicle sensor data may further include: gathering first sensor data from a first vehicle sensor;

gathering second sensor data from a second vehicle sensor; calculating a first estimated cognitive load based on the first sensor data; and calculating a second estimated cognitive load based on the second sensor data.

The determining that the cognitive load of the driver exceeds the cognitive load threshold may further include: determining that the first estimated cognitive load exceeds a first cognitive load threshold; determining that the second estimated cognitive load does not exceed a second cognitive load threshold; and determining that the cognitive load of the driver exceeds the cognitive load threshold based on the determination that the first estimated cognitive load exceeds the first cognitive load threshold.

The determining that the cognitive load of the driver exceeds the cognitive load threshold may further include: calculating a combined estimated cognitive load based on both the first estimated cognitive load and the second estimated cognitive load; and determining that the combined estimated cognitive load exceeds a combined cognitive load threshold; and determining that the cognitive load of the driver exceeds the cognitive load threshold based on the determination that the combined estimated cognitive load exceeds the combined cognitive load threshold.

In calculating the combined estimated cognitive load based on both the first estimated cognitive load and the second estimated cognitive load, the first estimated cognitive load and the second estimated cognitive load may be given different weights.

The first sensor data may be first driver sensor data indicative of a first characteristic of the driver, and the second sensor data may be second driver sensor data indicative of a second characteristic of the driver.

The first sensor data may be driver sensor data indicative of a characteristic of the driver, and the second sensor data may be environment sensor data indicative of an environmental characteristic of an interior of the vehicle.

The characteristic of the driver may include at least one of an estimated drowsiness of the driver, an estimated emotional state of the driver, an estimated attentiveness of the driver to a road in front of the vehicle, and an amount of time the driver is interacting with a human-machine interface.

The characteristic of the interior of the vehicle may include at least one of a sound level within the interior of the vehicle, a light level within the interior of the vehicle, a level of passenger movement within the interior of the vehicle, and an estimated level of passenger interaction with the driver.

The first plurality of vehicle features may include heating, ventilation, and cooling (HVAC) control and navigation control, and at least two of radio/media control, lighting control, streaming video control, streaming gaming control, weather data access, calendar data access and control, and mobile telephone control, and the second plurality of vehicle features may include heating, ventilation, and cooling (HVAC) control and navigation control, and at least one of radio control, lighting control, streaming video control, streaming gaming control, weather data, calendar data, and mobile telephone control.

The plurality of vehicle sensors may include one or more audio sensors configured to gather audio data indicative of noise in a cabin of the vehicle, the vehicle sensor data may include the audio data, and the estimating of the cognitive load of the driver based on the vehicle sensor data may further include determining if the noise level in the cabin of the vehicle is higher than an upper threshold decibel level based on the audio data, determining if the noise level in the cabin of the vehicle is lower than a lower threshold decibel level based on the audio data, increasing a distraction level when it is determined that the noise level in the cabin of the vehicle is higher than the upper threshold decibel level, decreasing the distraction level when it is determined that the noise level in the cabin of the vehicle is lower than the lower threshold decibel level, determining the cognitive load of the driver based on the distraction level.

The operations of determining if the noise level in the cabin of the vehicle is higher than an upper threshold decibel level, determining if the noise level in the cabin of the vehicle is lower than a lower threshold decibel level, increasing a distraction level when it is determined that the noise level in the cabin of the vehicle is higher than the upper threshold decibel level, decreasing the distraction level when it is determined that the noise level in the cabin of the vehicle is lower than the lower threshold decibel level, and determining the cognitive load of the driver based on the distraction level may be repeated over time.

The plurality of vehicle sensors may includes one or more camera sensors configured to gather video data relating to the driver, the video data being indicative of the driver being in one of at least one emotional state, the at least one emotional state may include at least one of anger, joy, and surprise, the at least one emotional state may each be associated with an emotional confidence modifier, the vehicle sensor data may include the video data, and the estimating of the cognitive load of the driver based on the vehicle sensor data may further include determining whether the driver is in one of the at least one emotional state based on the video data, determining that the driver is in a detected emotional state selected from the at east one emotional state based on the video data when it is determined that the driver is in one of the at least one emotional state, modifying an emotional confidence value by the emotional confidence modifier associated with the detected emotional state, and estimating the cognitive load of the driver based on the emotional confidence value.

The operations of determining whether the driver is in one of the plurality of emotional states, determining that the driver is in a detected emotional state, modifying an emotional confidence value by the emotional confidence modifier associated with the detected emotional state, and estimating the cognitive load of the driver based on the emotional confidence value may be repeated over time.

The plurality of vehicle sensors may include one or more camera sensors configured to gather video data relating to the driver, the video data being indicative of whether a gaze of the driver is distracted from a road ahead of the vehicle,

the vehicle sensor data includes the video data, and the estimating of the cognitive load of the driver based on the vehicle sensor data may further include determining whether the gaze of the driver is distracted from the road based on the video data, increasing a current distraction level when it is determined that the gaze of the driver is distracted from the road, decreasing the current distraction level when it is determined that the gaze of the driver is not distracted from the road, and estimating the cognitive load of the driver based on the current distraction level.

The operations of determining whether the gaze of the driver is distracted from the road, increasing a current distraction level when it is determined that the gaze of the driver is distracted from the road, decreasing the current distraction level when it is determined that the gaze of the driver is not distracted from the road, and estimating the cognitive load of the driver based on the current distraction level may be repeated over time.

The plurality of vehicle sensors may include one or more camera sensors configured to gather video data relating to the driver, the video data being indicative of whether the driver is drowsy, the vehicle sensor data may include the video data, and the estimating of the cognitive load of the driver based on the vehicle sensor data may further include determining whether the driver is drowsy based on the video data, increasing a current distraction level when it is determined that the driver is drowsy, decreasing the current distraction level when it is determined that the driver is not drowsy, and estimating the cognitive load of the driver based on the current distraction level.

The operations of determining whether the driver is drowsy, increasing a current distraction level when it is determined that the driver is drowsy, decreasing the current distraction level when it is determined that the driver is not drowsy, and estimating the cognitive load of the driver based on the current distraction level may be repeated over time.

The plurality of vehicle sensors may include a human-machine interface (HMI) configured to gather HMI data indicative of how many times the driver interacts with the HMI during a set time period, the vehicle sensor data may include the HMI data, and the estimating of the cognitive load of the driver based on the vehicle sensor data may further include determining whether the driver has interacted with the HMI during the set time period based on the HMI data, increasing a current distraction level when it is determined that the driver has interacted with the HMI during the set time period, decreasing the current distraction level when it is determined that the driver has not interacted with the HMI during the set time period, and estimating the cognitive load of the driver based on the current distraction level.

The operations of determining whether the driver has interacted with the HMI during the set time period, increasing a current distraction level when it is determined that the driver has interacted with the HMI during the set time period, decreasing the current distraction level when it is determined that the driver has not interacted with the HMI during the set time period, and estimating the cognitive load of the driver based on the current distraction level may be repeated over time.

The subset of the first plurality of vehicle features that forms the second plurality of vehicle features may be configured to be modifiable based on previous vehicle sensor data from the plurality of vehicle sensors and related determinations regarding a driver status of the driver and an environmental status of the interior of the vehicle.

The subset of the first plurality of vehicle features that forms the second plurality of vehicle features may be configured to be modifiable based on input from the driver.

A selection of the plurality of vehicle sensors from a number of available vehicle sensors may be configured to be modifiable based on input from the driver.

A selection of possible distractions monitored by the plurality of vehicle sensors may be configured to be modifiable based on input from the driver.

The processor may be further configured to facilitate: identifying one or more mitigating activities in response to determining that the cognitive load of the driver exceeds the cognitive load threshold, the one or more mitigating activities being predicted to reduce distraction of the driver; and announcing the one or more mitigating activities to the driver.

The one or more mitigating activities may include one or more of suggesting stopping the vehicle at a nearby location, changing ambient light in the vehicle interior, and playing specific audio inside the vehicle interior.

The operation of determining that the cognitive load of the driver exceeds the cognitive load threshold may further include: receiving a voice command from the driver indicating that the cognitive load of the driver exceeds the cognitive load threshold.

### BRIEF DESCRIPTION OF THE DRAWINGS

The accompanying figures, where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is a block diagram of a driver distraction mitigation system according to disclosed embodiments;

FIG. 2 is a block diagram of the vehicle controller of FIG. 1 according to disclosed embodiments;

FIG. 3 is a block diagram of the vehicle sensors of FIG. 1 according to disclosed embodiments;

FIG. 4 is a block diagram of the camera sensors of FIG. 3 according to disclosed embodiments;

FIG. 5 is a block diagram of the information/entertainment circuit of FIG. 1 according to disclosed embodiments;

FIG. 6 is a block diagram of the processor of FIG. 2 according to disclosed embodiments;

FIG. 7 is a representative diagram of vehicle control systems in a vehicle according to disclosed embodiments;

FIG. 8 is a representative diagram of vehicle cameras in a vehicle according to disclosed embodiments;

FIG. 9 is a representative diagram of vehicle audio sensors and speakers in a vehicle according to disclosed embodiments;

FIG. 10 is a representative diagram of additional vehicle sensors in a vehicle according to disclosed embodiments;

FIG. 11 is a flow chart of the operation of vehicle driver distraction mitigation system according to disclosed embodiments;

FIG. 12 is a flow chart of the operation of gathering vehicle sensor data of FIG. 11 according to disclosed embodiments;

FIG. 13 is a flow chart of the operation of estimating cognitive load of FIG. 11 according to disclosed embodiments;

FIG. 14 is a flow chart of the operation of determining if cognitive load is greater than a threshold cognitive load of FIG. 11 according to first disclosed embodiments; and

FIG. 15 is a flow chart of the operation of determining if cognitive load is greater than a threshold cognitive load of FIG. 11 according to second disclosed embodiments.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs), such as dynamic random access memory (DRAM) devices, static random access memory (SRAM) devices, or the like. In particular, they may be implemented using CMOS transistors. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

### Driver Distraction Mitigation System

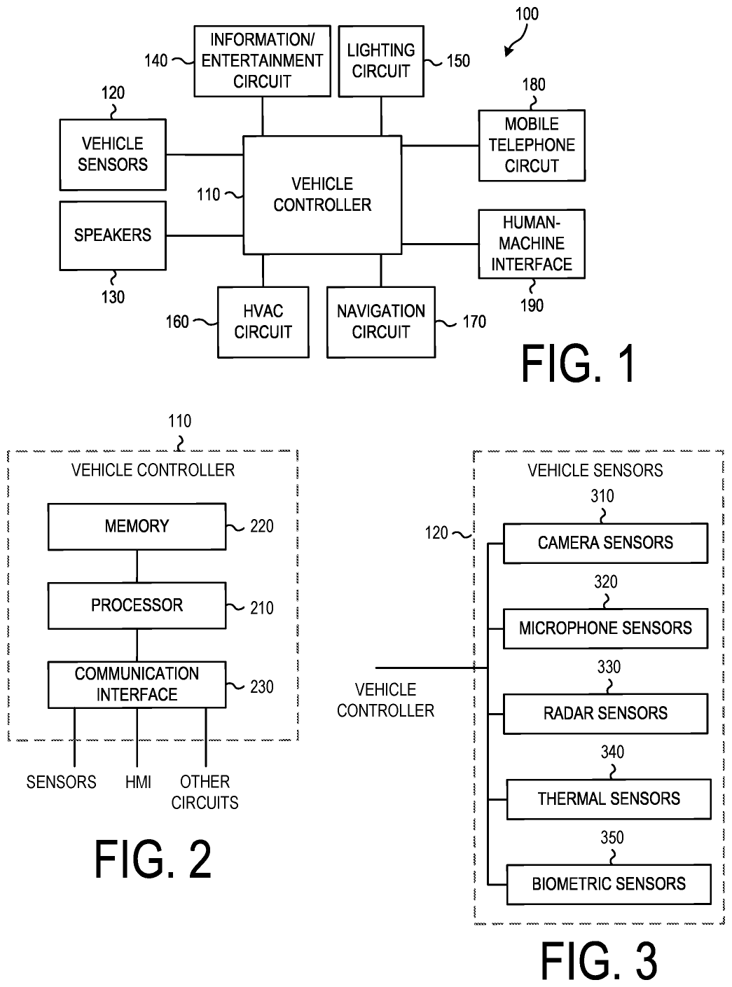

FIG. 1 is a block diagram of a driver distraction mitigation system 100 according to disclosed embodiments. As shown in FIG. 1, the driver distraction mitigation system 100 includes a vehicle controller 110, a plurality of vehicle sensors 120, one or more speakers 130, an information/entertainment circuit 140, a lighting circuit 150, an HVAC circuit 160, a navigation circuit 170, a mobile telephone circuit 180, and a human-machine interface (HMI) 190.

The vehicle controller 110 is configured to control the operation of the driver distraction mitigation system 100. It receives data from and provides control signals to the vehicle sensors 120, the speakers 130, the information/entertainment circuit 140, the lighting circuit 150, the HVAC circuit 160, the navigation circuit 170, circuit 180, the HMI 190, and any other circuit that requires control signals.

The plurality of vehicle sensors 120 are placed at different locations in the interior and exterior of the vehicle and are configured to measure a variety of parameters at various positions inside or outside the vehicle. For example, the vehicle sensors 120 could gather image data, sound data, radar data, sonar data, thermal data, biometric data, or any desired data provided by a sensor device.

The one or more speakers 130 are placed at different locations in the interior of the vehicle and are configured to output audio information to the occupants of the vehicle. This audio information can include spoken words, alarms, music, or any other audio information the system 100 needs to convey to the occupants of the vehicle.

The information/entertainment circuit 140 offers an opportunity for the occupants of the vehicle to access information or entertainment while in the vehicle. This may include broadcast or streaming audio, streaming video, streaming games, weather data, calendar data, or any other information or entertainment event that may be facilitated within the vehicle. The information and/or entertainment provided by the information/entertainment circuit 140 may be accessible by the driver only, both the driver and passengers, or only the passengers, depending upon the nature of the information/entertainment.

The lighting circuit 150 includes controls for operating internal and external lighting for the vehicle. For example, it could include dashboard controls to regulate the status and brightness of the vehicle headlights, any interior dome light, and any additional interior lighting in the vehicle.

The HVAC circuit 160 includes the controls for regulating the heating, cooling, and air distribution system for the vehicle. It can include dashboard controls to regulate the status, temperature, fan speed, and the like of an HVAC system for the vehicle.

The navigation circuit 170 includes a navigation display and the controls for manipulating the navigation display to show a map of a desired area. This may further include the controls necessary to search for maps, browse maps of an area, identify one or more roots to a particular destination, select a desired route, provide map or route information, and like.

The mobile telephone circuit 180 includes controls for coordinating the association of a mobile telephone with the vehicle control circuits, and the operation of any associated mobile telephone using vehicle controls rather than controls located on the mobile telephone. This can include the ability to make and receive calls using only the HMI 190, or the ability to make and receive calls using only voice recognition.

The HMI 190 allows the occupants of the vehicle to provide data to and receive information from the vehicle controller 110. In various embodiments, the human-machine interface can include a touchpad, a keyboard, a display with touch buttons, or any suitable device for allowing communication between the vehicle controller 110 and the occupants. In various embodiments, the HMI can serve as an input/output device for any or all of the information/entertainment circuit 140, the lighting circuit 150, the HVAC circuit 160, the navigation circuit 170, the mobile telephone circuit 180, or any other circuit that requires data to be input or output.

Although FIG. 1 shows a specific variety of devices connected to the vehicle controller 110, this is by way of example only. The system 100 must contain the vehicle sensors 120 and the human-machine interface 190, but the configuration of the remaining circuits may vary. In some embodiments fewer circuits may be provided than are shown; in other embodiments, additional circuits may be provided.

FIG. 2 is a block diagram of the vehicle controller 110 of FIG. 1 according to disclosed embodiments. As shown in FIG. 2, the vehicle controller 110 can include a processor 210, a memory 220, and a communication interface 230.

The processor 210 receives signals from and generates signals to control the vehicle sensors 120, the speakers 130, the information/entertainment circuit 140, the lighting circuit 150, the HVAC circuit 160, the navigation circuit 170, circuit 180, the human-machine interface 190, and any other circuit that requires control signals. The processor 210 can be a microprocessor (e.g., a central processing unit), an application-specific integrated circuit (ASIC), or any suitable device for controlling the operation of all or part of the vehicle climate control system 100.

The memory 220 is configured to store information and operation programs. The memory 220 can include a read-only memory (ROM), a random-access memory (RAM), an electronically programmable read-only memory (EPROM), an electrically erasable programmable read only memory (EEPROM), flash memory, or any suitable memory device.

The communications interface 230 is configured to transmit and receive communications over at least a portion of the driver distraction mitigation system 100. Although it is only shown in FIG. 2 as having signal lines connecting it to the sensors 120 and the human-machine interface 190, the reference to other circuits includes all other circuits that may either provide information to the processor 210 or receive instructions from the processor 210. This could include, but is not limited to, the speakers 130, the information/entertainment circuit 140, the lighting circuit 150, the HVAC circuit 160, the navigation circuit 170, circuit 180, or any other element within the driver distraction mitigation system 100 that needs instructions or provides data.

The connection implemented by the communication interface 230 could be wired or wireless between the communications interface 230 and any element in the driver distraction mitigation system 100 in various embodiments. In some embodiments the connections can be a mix of wired and wireless connections.

FIG. 3 is a block diagram of the vehicle sensors 120 of FIG. 1 according to disclosed embodiments. As shown in FIG. 3, the vehicle sensors 120 include camera sensors 310, microphone sensors 320, radar sensors 330, thermal sensors 340, and biometric sensors 350.

The camera sensors 310 include sensors that capture any sort of visual image. For example, the camera sensors could include static or video cameras for monitoring the inside or outside of the vehicle. These could include both RGB cameras (i.e., color cameras) or infrared (IR) cameras. The internal cameras can be provided to monitor the driver alone or the driver and the occupants of the vehicle. In some embodiments, the internal cameras provided to monitor the driver may be more sophisticated. For example, in some embodiments the internal cameras monitoring the driver may include both IR and RGB cameras, while the internal cameras monitoring the occupants may include only RGB cameras. This may vary in different embodiments. In alternate embodiments the RGB cameras could be replaced with black-and-white cameras that capture only a black-and-white image.

The microphone sensors 320 include sensors that capture audio data from inside or outside the vehicle. This audio data can include audio data suitable for voice recognition, a volume of sound inside the vehicle, or any type of audio data that could be used to identify potential driver distraction. For example, the microphone sensors 320 could potentially be used to identify the presence of nearby sirens, detect breaking glass, or the like.

Typically, the microphone sensors 320 will include multiple microphones located at different positions within the inside and/or outside of the vehicle. By having different microphones at different positions, it is possible to triangulate the sound's origination to estimate whether the sound comes from a driver or an occupant. The microphone sensors 135 can also detect where the sound is coming from, e.g., from the driver, from the front passenger, from the right middle passenger, etc.

The radar sensors 330 are circuits that use radar to detect a variety of parameters including, the presence of occupants inside a vehicle, the position of occupants inside the vehicle, the number of occupants inside the vehicle, whether objects are being inserted from outside the vehicle through the windows of the vehicle, or any other parameter could be detectable using a radar sensor 130. In alternate embodiments, the radar sensors 330 could include external radar sensors that can determine the proximity of another vehicle or land feature to the driven vehicle.

The thermal sensors 340 are placed at different locations in the interior of the vehicle and are configured to measure temperatures at various positions inside the vehicle. These thermal sensors 340 can be implemented, by way of example, using thermistors (i.e., thermally sensitive resistors), thermocouples, resistance temperature detectors (RTD), or infrared devices.

In some exemplary embodiments, the interior of the vehicle could be divided up into a plurality of zones, some or all of the zones having one or more of the thermal sensors 340 arranged to detect temperatures within that zone. In other embodiments, the interior of the vehicle could be considered a single zone in which the thermal sensors 340 operate.

In various embodiments, the thermal sensors 340 can be configured to detect a variety of temperatures, e.g., a temperature of an occupant in a corresponding zone, a temperature of the air in a corresponding zone, a temperature of an object within corresponding zone (e.g., a seat, a steering wheel, etc.), or the like. The thermal sensors can detect the location or position of the driver or a passenger, the body temperature of the driver or passenger, the internal temperature of the vehicle, or any other thermal information.

The biometric sensors 350 can be located in the vehicle proximate to the driver or can be attached to the driver, e.g., as a wearable device. They provide biometric data related to the driver to the vehicle controller 110. The biometric data can include the location of the driver, the driver's steering and speed inputs, whether the driver's hands are on the steering wheel, general hand and eye position of the driver, the driver's temperature and heart rate, or any suitable biometric information. In alternative embodiments, the biometric sensors 350 can include sensors directed at the occupants of the vehicle in addition to the driver.

Although the plurality of vehicle sensors 120 of FIG. 3 includes five different kinds of sensors, these are by way of example only. Alternate embodiments could include more or fewer types of sensors. For example, lidar and sonar could be used in some embodiments. Typically, at least one of the camera sensors 320 or microphone sensors 330 will be included in the group of vehicle sensors 120, even if their number is reduced.

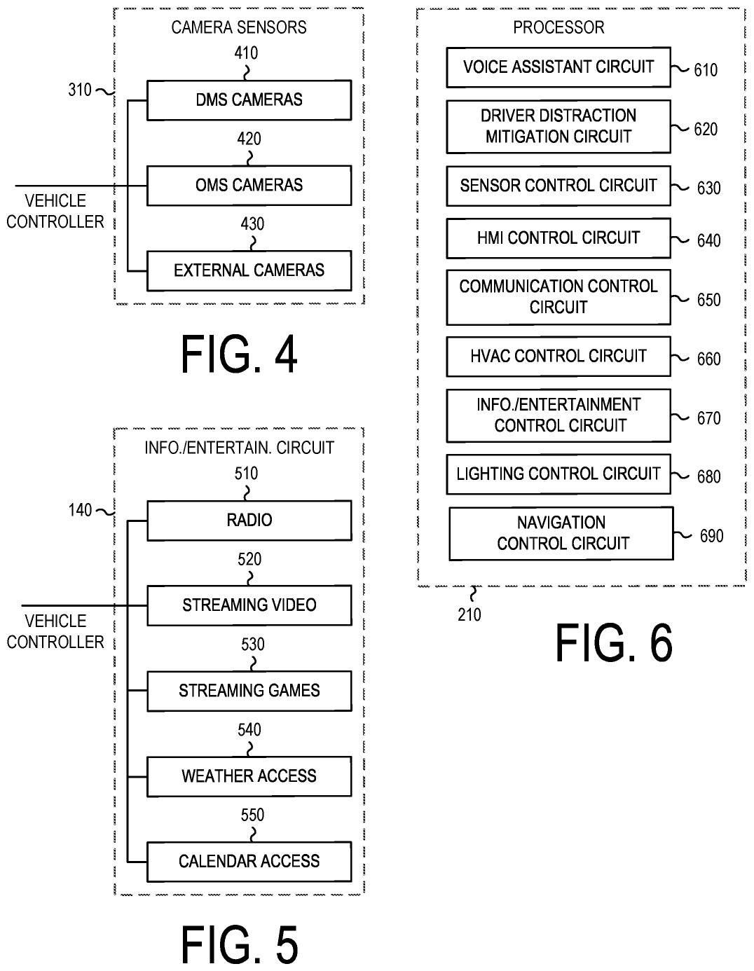

FIG. 4 is a block diagram of the camera sensors 310 of FIG. 3 according to disclosed embodiments. As shown in FIG. 4, in the camera sensors 310 may include driver monitoring system (DMS) cameras 410, occupant monitoring system (OMS) cameras 420, and external cameras 430.

The DMS cameras 410 operate to monitor only the driver. These can include infrared (IR) cameras and/or red-green-blue (RGB) cameras (sometimes called color cameras). The DMS cameras 410 are configured to capture image data corresponding to the type of camera, i.e., IR cameras will capture IR images, while RGB cameras will capture color images. In some embodiments, the RGB cameras could be replaced with black-and-white (BW) cameras.

The OMS cameras 420 operate to monitor any occupants of vehicle other than the driver. These can include IR cameras and/or RGB cameras. The DMS cameras 410 are configured to capture image data corresponding to the type of camera, i.e., IR cameras will capture IR images, while RGB cameras will capture color images. In some embodiments, the RGB cameras could be replaced with BW cameras.

The external cameras 420 operate to monitor the area surrounding the vehicle. These can include IR cameras and/or RGB cameras. The DMS cameras 410 are configured to capture image data corresponding to the type of camera, i.e., IR cameras will capture IR images, while RGB cameras will capture color images. In some embodiments, the RGB cameras could be replaced with BW cameras.

FIG. 5 is a block diagram of the information/entertainment circuit 140 of FIG. 1 according to disclosed embodiments. As shown in FIG. 5, the information/entertainment circuit 140 includes a radio 510, a streaming video circuit 520, a streaming game circuit 530, a weather access circuit 540, and a calendar access circuit 550.

The radio 510 provides output through the speakers 130. It can be connected to an antenna to receive broadcast or streaming radio and may be controllable via the HMI 190. In alternate embodiments the radio 510 could also conclude alternate means of audio entertainment such as a CD player, a connection to an electronic music player such as a mobile phone or iPod, or any suitable way of providing audio entertainment.

The streaming video circuit 520 provides audio and/or video output to occupants of the vehicle other than the driver. The streaming video circuit 520 can be connected to an antenna such that it can communicate wirelessly with a streaming service or a mobile telephone to provide streaming video/audio and may be controllable via the HMI 190. In the alternative, the streaming video circuit 520 could be replaced with a DVD or Blu-ray player for providing real-time audio or video to occupants of the vehicle other than the driver. Because of safety considerations, the streaming video circuit 520 is typically arranged such that the driver cannot view any streaming video, although it is possible that the driver may be able to control what is shown over the streaming video circuit 520.

The streaming game circuit 530 provides streaming game access to occupants of the vehicle other than the driver. The streaming came circuit 530 can be connected to antenna such that it can communicate wirelessly with a streaming service or a mobile telephone to provide the streaming games and may be controllable via the HMI 190. In the alternative, the streaming game circuit 530 could be replaced with a game box for providing real-time gaming data to occupants of the vehicle other than the driver. Because of safety considerations, the streaming game circuit 530 is typically arranged such that the driver cannot view any games, although it is possible that the driver may be able to control what games are played over the streaming game circuit 530.

The weather access circuit 540 allows the driver or any other occupant of the vehicle to access real-time weather data. The weather access circuit 540 can be connected to antenna such that it can communicate wirelessly with a weather service or a mobile telephone to receive the real-time weather data. The weather access circuit 540 can be controlled through the HMI 190.

The calendar access circuit 550 allows the driver or any other occupant of the vehicle to access a scheduling calendar. The calendar access circuit 550 can be connected to antenna such that it can communicate wirelessly with a remote database or a mobile telephone to receive the calendar data. The calendar access circuit 550 can be controlled through the HMI 190.

Although FIG. 5 shows five possible individual information/entertainment subcircuits, this is by way of example only. Alternate embodiments could employ more or fewer elements in the information/entertainment circuit 140.

### Central Processing Unit

FIG. 6 is a block diagram of the processor 210 of FIG. 2 according to disclosed embodiments. Specifically, it shows the functional circuits within the processor 210. As shown in FIG. 6, the processor 210 can include a voice assistant circuit 610, a driver distraction mitigation circuit 620, a sensor control circuit 630, an HMI control circuit 640, a communication control circuit 650, an HVAC control circuit 660, an information/entertainment control circuit 670, a lighting control circuit 680, and a navigation control circuit 690. Each of these elements can be a physical portion of the circuit, a program stored in the memory 220, which is executed by the processor 210, or a combination of the two.

The voice assistant circuit 610 controls the operation of voice recognition in the system 100 and the use of voice commands to control the vehicle controller 110 or any relevant one of the various elements connected to the vehicle controller 110.

The driver distraction mitigation circuit 620 coordinates the inputs from the vehicle sensors 120, the determination as to whether and to what degree a driver is distracted, and the coordination of any mitigation actions or recommendations to be made based on the determination as to whether and to what degree the driver is distracted.

The sensor control circuit 630 controls the operation of the vehicle sensors 120 and coordinates the vehicle sensor data received from the various vehicle sensors 120 during the collection of vehicle data. This control and coordination can include providing data or signals to any other element of the system 100 that requests or requires those signals.

The HMI control circuit 640 controls the operation of the HMI 190 and coordinates the inputs received from the HMI 190 and the outputs provided to the HMI 190. This control and coordination can include providing data or signals to any other element of the system 100 that requests or requires those signals.

The communication control circuit 650 controls the operation of the mobile telephone circuit 180 and coordinates the inputs received from the mobile telephone circuit 180 and the outputs provided to the mobile telephone circuit 180. This control and coordination can include providing data or signals to any other element of the system 100 that requests or requires those signals.

The HVAC control circuit 660 controls the operation of the HVAC circuit 160. It can do so based on programs in the memory 220 or based on instructions received from the HMI 190 or the vehicle sensors 120.

The information/entertainment control circuit 670 controls the operation of the information/entertainment circuit 140. It can do so based on programs in the memory 220 or based on instructions received from either the HMI 190 or the mobile telephone circuit 180.

The lighting control circuit 680 controls the operation of the lighting circuit 150. It can do so based on programs in the memory 220 or based on instructions received from the HMI 190 or the vehicle sensors 120.

The navigation control circuit 690 controls the operation of the navigation circuit 170. It can do so based on programs in the memory 220 or based on instructions received from the HMI 190, the mobile telephone circuit 180, the driver distraction mitigation circuit 620, or the vehicle sensors 120.

Although FIG. 6 discloses nine separate control circuits in the processor 210, this is by way of example only. Alternate embodiments could have more or fewer control circuits depending upon the elements in the system 100. Likewise, some control systems could be combined such that a single control system controls multiple elements in the system 100.

### Placement of System Elements in the Vehicle

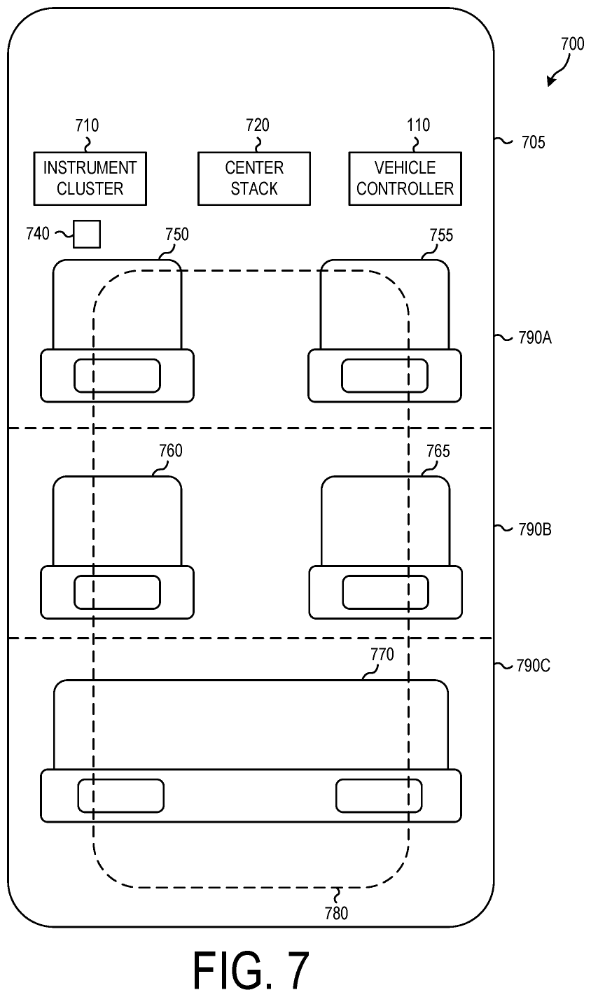

FIG. 7 is a representative diagram 700 of vehicle control systems in a vehicle 705 according to disclosed embodiments. As shown in FIG. 7, the vehicle 705 includes an instrument cluster 710, a center stack 720, a vehicle controller 110, a set of controls 740, a driver seat 750, a front passenger seat 755, a left middle passenger seat 760, a right middle passenger seat 765, and a rear seat 770. The dashed line 780 represents the location of the vehicle roof. The vehicle is divided into a front zone 790A containing the driver seat 750 and the front passenger seat 755; a middle zone 790B containing the left middle passenger seat 760 and the right middle passenger seat 765; and a rear zone 790C containing the rear seat 770.

The vehicle 705 may be any suitable means of transportation. In many embodiments it will be automobile and the following discussion will describe it as such. However, that is only by way of example. In alternate embodiments the vehicle could be a boat, airplane, train, or any vehicle that could gain benefit from having its driver have a greater degree of concentration and a reduced degree of distraction.

The instrument cluster 710 is a group of instruments used by the driver for driving the vehicle 705. It can include a speedometer, an odometer, a tachometer, and any other instrument or display required to assist the driver. In some embodiments it will be provided directly in front of the driver seat 750 for easy access by the driver.

The center stack 720 is a series of controls and control bearing surfaces located in the front of the vehicle between the driver seat 750 and the front passenger seat 755. It may have such instruments as a gear stick, controls and displays for the information/entertainment circuit 140, controls for the lighting circuit 150, controls and displays for the HVAC circuit 160, controls and displays for the navigation circuit 170, controls and displays for the mobile telephone circuit 180, and the HMI 190. In some embodiments, the controls and displays for a variety of these elements can be combined in a single touch screen. In alternate embodiments some or all of the controls and displays may be provided individually for different circuits.

The vehicle controller 110 is as described with respect to FIG. 2 and is typically provided out of sight of the interior of the vehicle 705.

The set of controls 740 includes all of the driver's controls that are not provided in the center stack 720. These can include turn signals, window wiper controls, gas pedal, brake pedal, and the like.

Although in the disclosed embodiment some control circuits are indicated as being on the center stack 720 while others are provided in the set of controls 740, this is by way of example only. Various controls can be provided in either or both of the center stack 720 or set of controls 740. In some embodiments controls can be split between the center stack 720 and the set of controls 740 for some functions.

Although the embodiment of FIG. 7 includes a driver seat 750, a front passenger seat 755, a left middle passenger seat 760, a right middle passenger seat 765, and a rear seat 770, this is by way of example only. Alternate embodiments could have more or fewer rows of seats, divided into more or fewer zones. The middle seats 760, 765 could be combined into a single, wide seat, or more than two middle seats could be provided. Likewise, the rear seat 770 could be split up into multiple individual seats. Additional seating zones could also be provided for additional seats.

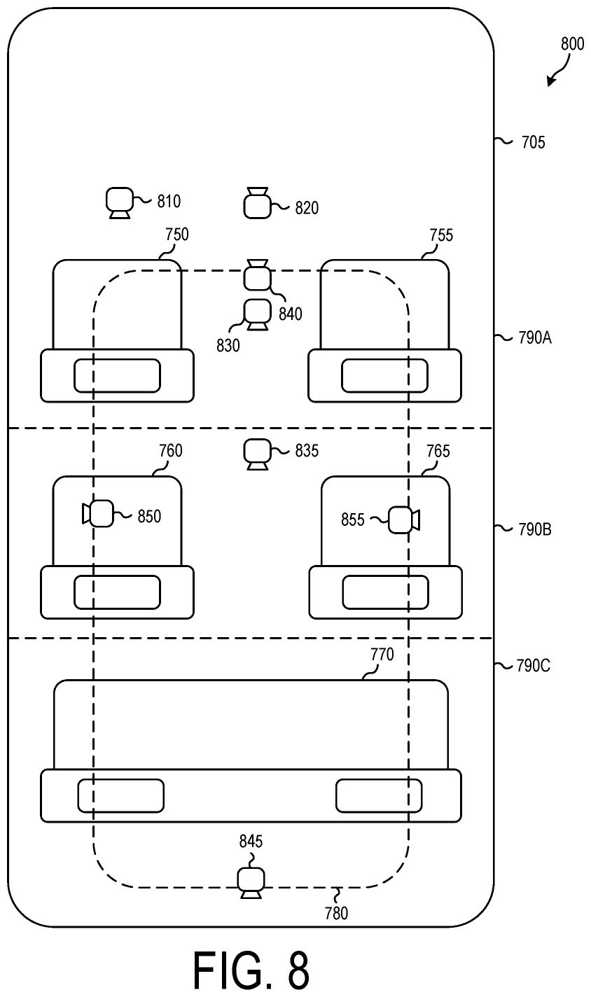

FIG. 8 is a representative diagram 800 of vehicle cameras in a vehicle 705 according to disclosed embodiments. Elements described above with respect to FIG. 7 operate as described above. As a result, their description will be omitted.

As shown in FIG. 8, the vehicle 705 includes one or more driver monitoring system (DMS) cameras 810, one or more internal front-facing cameras 820, one or more internal front-zone cameras 830, one or more internal middle-and-rear-zone cameras 835, one or more external front-facing cameras 840, one or more external rear-facing cameras 845, one or more external left-facing cameras 850, and one or more external right-facing cameras 855.

The one or more DMS cameras 810 corresponds to the DMS cameras 410 from FIG. 4. It can include one or both of an RGB camera and IR camera, though the RGB camera could be replaced by a BW camera. The one or more DMS cameras 810 monitor the driver, capturing IR images and/or color or black-and-white images of the driver and sends those driver images to the vehicle controller 210.

The one or more internal front-facing cameras 820 are cameras located inside the vehicle 705, but facing forward so that they capture front-facing images directly in front of the vehicle, i.e., images of the path the vehicle is taking and sends those front-facing images to the vehicle controller 210. The one or more internal front-facing cameras 820 can include one or both of an IR camera and an RGB camera, meaning that the front-facing images can be one or both of IR images and color images. Again, the RGB camera could be replaced with a BW camera.

The one or more internal front-zone cameras 830 are cameras located inside the vehicle 705, facing backward towards the front zone 790A of the interior of the vehicle so that they capture front occupant-facing images, i.e., images of the front passenger seat 755 and the area around the front passenger seat 755, and sends those front occupant-facing images to the vehicle controller 210. The one or more internal front-zone cameras 830 can include one or both of an IR camera and an RGB camera, meaning that the front-occupant images can be one or both of IR images and color images. Again, the RGB camera could be replaced with a BW camera.

The one or more internal middle-and-rear-zone cameras 835 are cameras located inside the vehicle 705, facing backward towards the middle and rear zones 790B, 790C of the interior of the vehicle so that they capture middle-and-rear-occupant images, i.e., images of the right and left middle passenger seats 760, 765 and the rear seat 770, and the areas surrounding the seats, and sends those middle-and-rear-occupant images to the vehicle controller 210. The one or more internal middle-and-rear-zone cameras 830 can include one or both of an IR camera and an RGB camera, meaning that the middle- and rear-occupant images can be one or both of IR images and color images. Again, the RGB camera could be replaced with a BW camera.

The one or more internal front-zone cameras 830 and the one or more internal middle and rear zone cameras 835 together correspond to the occupant monitoring system (OMS) cameras 420 from FIG. 4.

The one or more external front-facing cameras 840 are cameras located outside the vehicle 705 and facing forward so that they capture front-facing images directly in front of the vehicle, i.e., images of the path the vehicle 705 is taking, and sends those front-facing images to the vehicle controller 210. The one or more external front-facing cameras 840 can include one or both of an IR camera and an RGB camera, meaning that the front-facing images can be one or both of IR images and color images. Again, the RGB camera could be replaced with a BW camera.

The one or more external rear-facing camera 845 are cameras located outside the vehicle 705 and facing backward so that they capture backward-facing images directly behind the vehicle, i.e., images of the path the vehicle 705 has taken, and sends those rear-facing images to the vehicle controller 210. The one or more external rear-facing cameras 845 can include one or both of an IR camera and an RGB camera, meaning that the front-facing images can be one or both of IR images and color images. Again, the RGB camera could be replaced with a BW camera.

The one or more external left-facing camera 850 are cameras located outside the vehicle 705 and facing to the left side of the vehicle 705 so that they capture left-facing images to the left of the vehicle, i.e., images of terrain the vehicle 705 is passing, and sends those left-facing images to the vehicle controller 210. The one or more external left-facing cameras 850 can include one or both of an IR camera and an RGB camera, meaning that the front-facing images can be one or both of IR images and color images. Again, the RGB camera could be replaced with a BW camera.

The one or more external right-facing camera 855 are cameras located outside the vehicle 705 and facing right so that they capture right-facing images directly to the right of the vehicle, i.e., images of terrain the vehicle 705 is passing, and sends those right-facing images to the vehicle controller 210. The one or more external right-facing cameras 855 can include one or both of an IR camera and an RGB camera, meaning that the front-facing images can be one or both of IR images and color images. Again, the RGB camera could be replaced with a BW camera.

The one or more external front-facing cameras 840, one or more external rear-facing cameras 845, one or more external left-facing cameras 850, and one or more external right-facing cameras 855 together correspond to the external cameras 430 from FIG. 4.

The configuration of cameras provided in FIG. 8 is by way of example only. Alternate embodiments could use more or fewer cameras, and could very placement of the cameras.

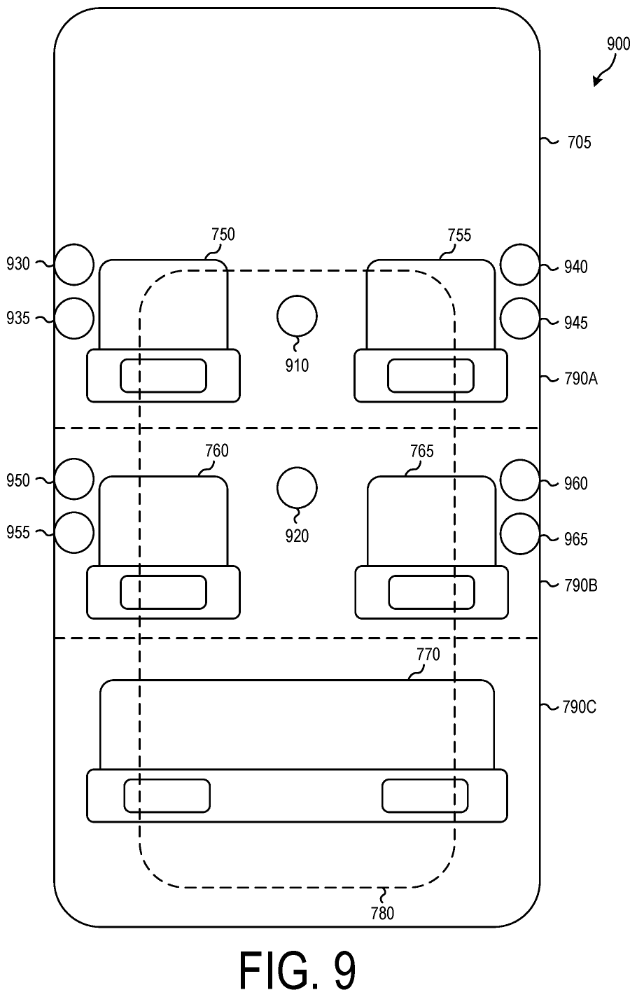

FIG. 9 is a representative diagram 900 of vehicle audio sensors and speakers in a vehicle 705 according to disclosed embodiments. Elements described above with respect to FIG. 7 operate as described above. As a result, their description will be omitted.

As shown in FIG. 9, the vehicle 705 includes a front microphone 910, a middle microphone 920, a first driver speaker 930, a second driver speaker 935, a first front passenger speaker 940, a second front passenger speaker 945, a first middle left speaker 950, a second middle left speaker 955, a first middle right speaker 960, and a second middle right speaker 965.

The front microphone 910 is an audio microphone configured to gather front audio data from the front zone 790A and send that front audio data to the vehicle controller 210. The front audio data can include voices from the driver and the front passenger or other sounds that may be loudest in the front zone 790A.

The middle microphone 920 is an audio microphone configured to gather middle-and-rear audio data from the middle and rea r zones 790B, 790C and send that middle-and-rear audio data to the vehicle controller 210. In this middle-and-rear audio data can include voices from the passengers in the middle and rear zones 790B, 790C or other sounds that may be loudest in the middle and rear zones 790B, 790C.

The front microphone 910 and the middle microphone 920 together correspond to the microphone sensors 320 from FIG. 3.

The first driver speaker 930 and the second driver speaker 935 are located in the front zone 790A next to the front driver seat 750. Together they provide sound directed toward the driver seat 750.

The first front passenger speaker 940 and the second front passenger speaker 945 are located in the front zone 790A next to the front passenger seat 755. Together they provide sound directed toward the front passenger seat 755.

The first middle left speaker 950 and the second middle left speaker 955 are located in the middle zone 790B next to the middle left passenger seat 760. Together they provide sound directed toward the middle left passenger seat 760.

The first middle right speaker 960 and the second middle right speaker 965 are located in the middle zone 790B next to the middle right passenger seat 765. Together they provide sound directed toward the middle right passenger seat 765.

The first driver speaker 930, the second driver speaker 935, the first front passenger speaker 940, the second front passenger speaker 945, the first middle left speaker 950, the second middle left speaker 955, the first middle right speaker 960, and the second middle right speaker 965 together correspond to the speakers 130 from FIG. 1.

Although no speakers are provided in the rear zone 790C, sound should reach the rear zone 790C from the first middle left speaker 950, the second middle left speaker 955, the first middle right speaker 960, and the second middle right speaker 965. Alternate embodiments could provide speakers at one or both ends of the rear zone 790C.

The configuration of speakers and microphones provided in FIG. 9 is by way of example only. Alternate embodiments could use more or fewer microphones, more or fewer speakers, and could very placement of the microphones and speakers.

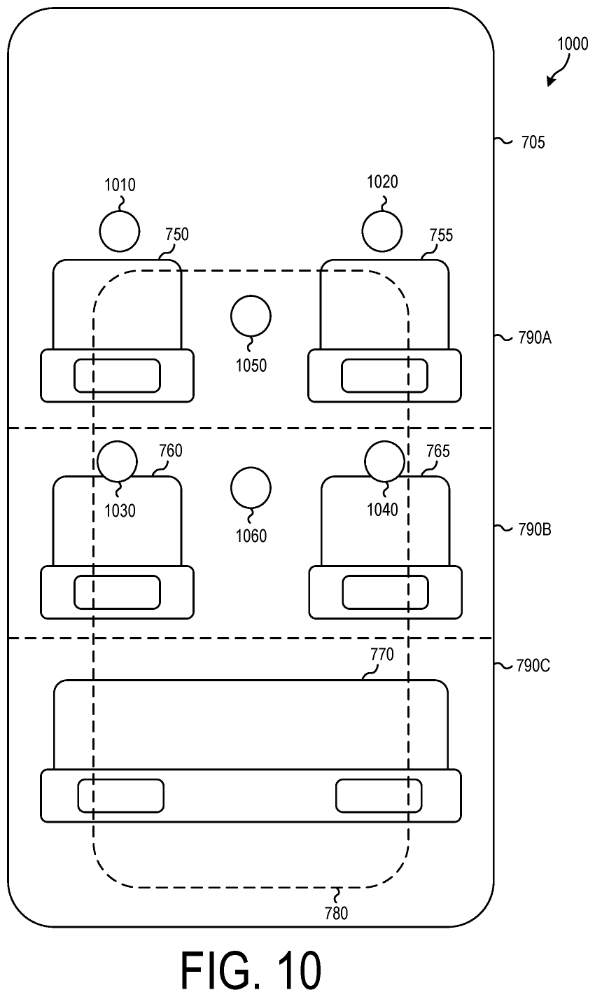

FIG. 10 is a representative diagram 1000 of additional vehicle sensors in a vehicle 705 according to disclosed embodiments. Elements described above with respect to FIG. 7 operate as described above. As a result, their description will be omitted.

As shown in FIG. 10, the vehicle 705 includes a driver thermal sensor 1010, a front passenger thermal sensor 1020, a left middle thermal sensor 1030, a right middle thermal sensor 1040, a front radar sensor 1050, and a middle radar sensor 1060.

The driver thermal sensor 1010 collects driver thermal data in the area around the driver seat 750 and provides that driver thermal data to the vehicle controller 210. The driver thermal data can indicate the position of the driver, the temperature of the driver, the temperature around the driver seat 750, or the like.

The front passenger thermal sensor 1020 collects front passenger thermal data in the area around the front passenger seat 755 and provides that front passenger thermal data to the vehicle controller 210. The front passenger thermal data can indicate the presence of a front passenger, the position of the front passenger, the temperature of the front passenger, the temperature of the area around the front passenger seat 755, or the like.

The left middle thermal sensor 1030 collects left middle thermal data in the area around the left middle passenger seat 760 and provides that left middle thermal data to the vehicle controller 210. The left middle thermal data can indicate the presence of a left middle passenger, the position of the left middle passenger, the temperature of the left middle passenger, the temperature of the area around the left middle passenger seat 760, or the like.

The right middle thermal sensor 1040 collects right middle thermal data in the area around the right middle passenger seat 765 and provides that right middle thermal data to the vehicle controller 210. The right middle thermal data can indicate the presence of a right middle passenger, the position of the right middle passenger, the temperature of the right middle passenger, the temperature of the area around the right middle passenger seat 765, or the like.

The driver thermal sensor 1010, the front passenger thermal sensor 1020, the left middle thermal sensor 1030, and the right middle thermal sensor 1040 together correspond to the thermal sensors 340 from FIG. 3.

The front radar sensor 1050 collects front radar data in the front zone 790A and provides the front radar data to the vehicle controller 210. The front radar data can indicate the presence of a front passenger, the position of the driver or front passenger, movement in or out of one of the front windows, or the like.

The middle radar sensor 1060 collects middle and rear radar data in the middle and rear zones zone 790B, 790C and provides the middle and rear radar data to the vehicle controller 210. The middle and rear radar data can indicate the presence of a middle or rear passenger, the position of the middle or rear passengers, movement in or out of one of the middle or rear windows, or the like.

The front radar sensor 1050 and the middle radar sensor 1060 together correspond to the radar sensors 330 from FIG. 3.

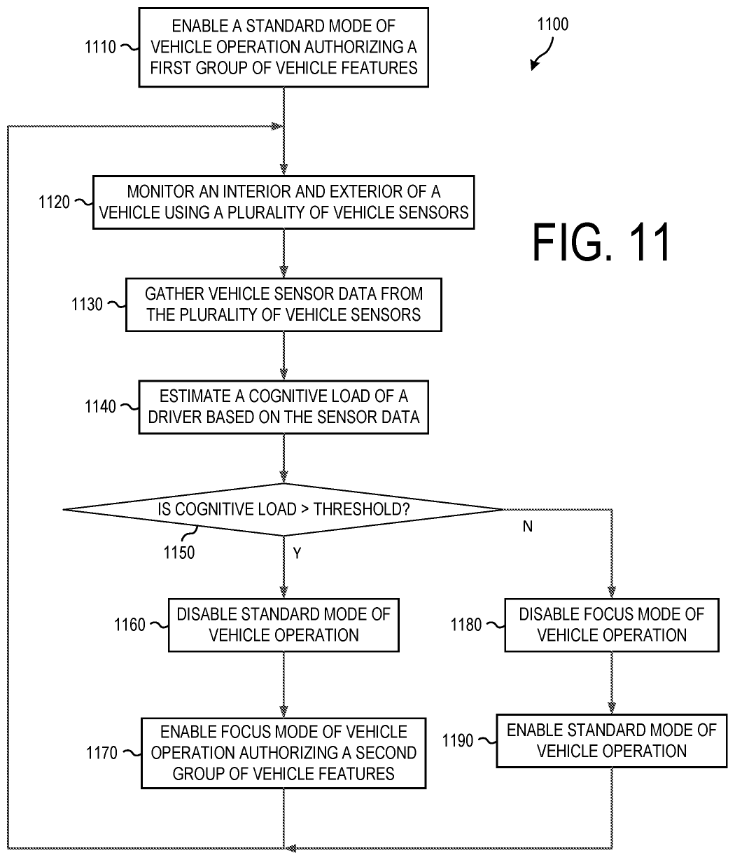

The configuration of other sensors provided in FIG. 11 is by way of example only. Alternate embodiments could use more or fewer other sensors of differing type, and could very placement of the other sensors.

### Driver Distraction

As shown in FIGS. 1-6, the drivers and passengers of the vehicle have access to many features that they can use during operation of the vehicle. These features can provide multiple distractions to a driver, whether directly or indirectly. A driver might be directly distracted by manipulating radio, lighting, HVAC, mobile telephone, or navigation controls, and might be indirectly distracted by noise from streaming video or streaming games. Furthermore, additional sources of distraction exist such as drowsiness, lack of attention to the road, improper attention to a cell phone, movement of passengers, noise made by passengers, and the like. Several examples of types of distractions and how they are identified are provided below.

One type of distraction is gaze distraction in which the driver is distracted from having their gaze directed ahead of the vehicle. The system follows the following steps to successfully detect gaze distraction.

Gaze direction can be detected using the DMS cameras 410, which outputs a software value indicative of where the driver is looking. Given the detected gaze direction, the software can then calculate the direction that the driver is looking. This detected direction is then used to determine if the driver's eyes are watching the road or not. If the driver looks away from the road, the distraction level for this event increases; and if the driver is watching the road, the distraction level for this event decreases. When the distraction level reaches 100%, a gaze distraction event is triggered.

Another type of distraction is drowsiness in which the driver is too sleepy to properly focus on driving. The system follows the following steps to successfully detect drowsiness.

Drowsiness can be detected using the DMS cameras 410, which output a software output value indicative of the drivers drowsiness based on head movement and facial features. This value is a confidence level of the drowsiness detected. If the confidence value exceeds a drowsiness confidence value threshold, the system increases the drowsiness distraction level. If the confidence value is below the drowsiness confidence value threshold, the system decreases the drowsiness distraction level. When the drowsiness distraction level reaches 100%, a drowsiness distraction event is triggered.

Another type of distraction is emotion, which can cause the driver to not pay sufficient attention to the road. The system follows the following steps to successfully detect emotional distraction. Emotions can be detected using the DMS cameras 410 which output a software output value indicative of the driver's current level in a given emotional state. The value is a confidence level of the emotion detected. There are multiple emotion options, including anger, joy, and surprise, and there is a separate confidence level output for each monitored emotion available. If the corresponding emotional confidence value exceeds the emotional confidence value threshold, the system increases the corresponding emotional distraction level. Some emotions, when detected, increase the distraction level by a greater amount than others. If the corresponding emotional confidence value is below the corresponding emotional confidence value threshold, the system decreases the corresponding emotional distraction level. When the distraction level for a given emotion reaches 100%, an emotional distraction event is triggered.

Passenger distraction is another type of distraction, through which the actions of the passengers in the vehicle distract the driver. The system follows the following steps to successfully detect passenger distraction.

The noise level inside the vehicle can be detected by one or more of the microphones. If the noise level exceeds a set decibel level, a passenger distraction level is increased. If a set time passes time without noise exceeding the set decibel level, the passenger distraction level is decreased. When the passenger distraction level reaches 100%, a passenger distraction event is triggered.

HMI distraction is another type of distraction in which driver continually operating the HMI distracts them from driving. The system follows the following steps to successfully detect HMI distraction.

The HMI distraction is determined based on the touch sample rate of the touch screen of the HMI 190. A percentage is determined by how much the screen was touched over a set time period, e.g., a 10 second period. If the percentage value over the set time period is greater than 0, the system adds to the HMI distraction level. If the percentage value over the set time period is 0, the HMI distraction level is decreased. When the HMI distraction level reaches 100%, an HMI distraction event is triggered.

These potential sources of distraction are provided by way of example only. Many other possible sources of distraction can be monitored based on a variety of different sensor information.

After a distraction event is triggered, the event is preferably logged and the driver could be offered distraction mitigation suggestions. This can be either done by the HMI circuit 190 or by a voice assistant if such is provided via the vehicle controller 110.

Each of these sources of distraction can individually distract a driver or may combine to form a significant distraction together. For example, the loudness of the radio 510, movement by a passenger inside the vehicle, and a need to manipulate the navigation circuit 170 may individually represent a lower level of distraction. However, when the three are combined, the cumulative distraction may rise to a level that would be considered hazardous.

Therefore, it is desirable to not only monitor individual sources of distraction, but also to monitor a cumulative level of distraction based on multiple sources of distraction. For example, multiple distractions that don't rise to the level of an individual distraction event could collectively constitute a distraction event, even though individually any one would not ruse to that level.

Furthermore, not all sources of distraction are the same for all drivers. A driver may consider that a particular source of distraction is not significant, or the driver distraction mitigation system 100 could learn over time that a particular driver is less susceptible to a certain type of distraction. Therefore, the driver distraction mitigation system 100 may include a feature whereby the driver can select specific types of distraction that will be omitted from consideration in the driver distraction mitigation system 100, or might be given special consideration. Likewise, in the driver distraction mitigation system 100 itself might gather data regarding the types of distractions that a particular driver falls prey to and may determine that certain types of distraction are so rare that it will omit consideration of those types of distraction from its distraction prediction for certain drivers. In these cases, it may be necessary to include the functionality of face or voice detection to properly identify individual drivers so that their preferences and statistics can be properly accessed and used.

In each case, this information would be stored in the memory 220 of the vehicle controller 110, to allow the processor 210 to properly control a driver distraction mitigation operation.

### Method of Mitigating Driver Distraction in a Vehicle

FIG. 11 is a flow chart 1100 of the operation of vehicle driver distraction mitigation system according to disclosed embodiments.

As shown in FIG. 11, operation starts by enabling a standard mode of vehicle operation authorizing a first group of vehicle features. (1110) This first group of vehicle features is typically a relatively large group of features, possibly all available features, since the system starts with no driver distraction identified. Thus, the driver will have access to the relatively large number of features.

The operation than monitors and interior and exterior of the vehicle using a plurality of vehicle sensors. (1120) These sensors will generally include at least one of video or audio sensors, and then any number of other sensors, including radar sensors, thermal sensors, biometric sensors, sonar sensors, lidar sensors, etc. In some alternate embodiments, however, the monitoring can be limited to only the interior of the vehicle.

The operation then gathers vehicle sensor data from this plurality of vehicle sensors. (1130) This can involve sending data from the vehicle sensors to a vehicle controller for consideration.

The operation then estimates a cognitive load of a driver based on the sensor data received from the vehicle sensors. (1140) This can be achieved in a variety of ways. For example, individual sensor data can be analyzed on its own to gauge specific sources of distraction and the estimated degree of such distraction. For example, internal video image data can be used to analyze a driver's body and face to determine a level of drowsiness or emotional state, e.g., sad, angry, or happy. Image data could also be used to examine a driver's head and face to determine whether they are paying attention to the road, to a mobile phone, to a mirror, to an HMI, or to something else. Audio data could be used to determine if the sound inside the vehicle has become too loud or if certain repetitive sounds are being made, e.g., a baby's cry. Audio data could also be used to determine if there is a siren going off nearby the vehicle, or any information that could be obtained from audio data. Radar data can be used to determine if people or pets are moving around inside the vehicle. Thermal data can be used to determine if the driver appears to be ill.

In addition, data from a variety of circuits within the vehicle can also be used by a vehicle controller to determine distraction. For example, the amount of use of a human-machine-interface (HMI) can be used to determine if the driver is spending a large amount of time manipulating the HMI, the amount of time spent manipulating the radio can be used to determine if the driver is spending a large amount of time manipulating the radio, and the amount of time spent manipulating the HVAC circuit can be used to determine if the driver is spending a large amount of time manipulating the HVAC circuit.

The system can maintain an estimated cognitive load for each identified potential distraction. In the disclosed embodiment this cognitive load is represented as a percentage value, with 0% representing no distraction, though this is by way of example only. Different embodiments could employ a different structure for the range of cognitive loads. However, each cognitive load will have a cognitive load threshold value over which the cognitive load is considered large enough that the driver will be distracted by it. That cognitive load threshold is 100% for each distraction in the disclosed embodiments. Therefore, in the disclosed embodiments, once the cognitive load for any given potential distraction rises to 100% or greater, the system will determine that the driver is distracted by that potential distraction. For example, if the cognitive load for drowsiness rose to 100% or greater, the system would determine that the driver's drowsiness was sufficient that it was likely distracting them.

The cognitive load threshold can vary in different embodiments and need not be the same for each potential distraction. For example, in one embodiment, the cognitive load threshold for drowsiness might be 90%, while the cognitive load threshold for internal noise might be 120%. Multiple other variations are, of course, possible.

In operation, the system can periodically monitor the perspective sensors that identify a given potential distraction. At each time interval, the system can determine whether there is an indication of distraction or no indication of distraction. If there is an indication of distraction, the cognitive load for that potential distraction can be increased by a given increment. Likewise, if there is no indication of distraction, the cognitive load for that potential distraction may be decreased by a given increment. These two increments may or may not be the same. In this way, the system maintains a running cognitive load for each potential distraction.

More generically, each potential distraction will have a set of criteria for when to raise the cognitive load and when to lower the cognitive load. In some embodiments they may also have a set of criteria for when to maintain the cognitive load at its same value.

For example, in observing whether the HMI is being used too much, the system can monitor whether the driver touches the HMI during a given time period. If the driver does touch the HMI during that time period, then the system increases the cognitive load for HMI interaction; and if the driver does not touch the HMI during that time period, then the system decreases the cognitive load for HMI interaction.

The values for the cognitive load for each potential distraction can be used individually or collectively. If used individually, they will be considered one-by-one. If used collectively they can either be averaged or arranged in a weighted average to determine whether they collectively rise above a set collective cognitive load threshold. In some embodiments a combination of individual and collective determinations can be made.

If a collective cognitive load is used, a lower collective cognitive load threshold could be used as compared to the individual cognitive load thresholds. This could depend on the number of cognitive loads considered. For example, the cognitive load threshold for a single potential distraction might be 100%, while the cognitive load threshold for two combined potential distractions might be 95%, and the cognitive load threshold for three combined potential distractions might be 90%. Multiple other variations are, of course, possible.

Once the system has an estimate of the cognitive load for each possible distraction, it determines whether the cognitive load is above the cognitive load threshold. (1150)

In the case of individual determinations, this the system might determine that the cognitive load is above the cognitive load threshold when a single possible distraction has a cognitive load above its respective cognitive load threshold. Alternatively, it could require that a certain number of possible distractions have a cognitive load respective threshold for the overall cognitive load to be considered above threshold. For example, it might require that two possible distractions have a cognitive load above their respective cognitive load threshold for the overall cognitive load to be considered above the overall cognitive load threshold.

In the case of collective determinations, the individual cognitive loads can be averaged or made into a weighted average and the resulting averaged cognitive load could be compared to its own averaged cognitive load threshold. If the average cognitive load is greater than the averaged cognitive load threshold, then the overall cognitive load is considered to be above the overall cognitive load threshold.

For a weighted average, some potential distractions could be considered more likely to create a distraction and be assigned a relatively higher weight, while other potential distractions could be considered less likely to create a distraction and be assigned a relatively lower weight.

If the cognitive load is determined to be higher than the cognitive load threshold, the system will disable the standard mode of vehicle operation. (1160) If the standard mode of vehicle operation were already disabled, the system would simply maintain the disabled status of the standard motor vehicle operation. After disabling the standard mode of operation, the system will enable a focus mode of vehicle operation that authorizes a second group of vehicle features that is smaller than the first group of vehicle features. (1170) In doing so, the system will lower the chance of distraction by limiting the available features the driver can access and therefore the reduce the number of possible sources of distraction to the driver. If the system were already in a focus mode, then this letter operation would simply maintain the system in the focus mode.

For example, the standard mode of vehicle operation may allow for all vehicle features to be used. In contrast, the focus mode of operation might eliminate streaming video, streaming games, and mobile telephone access, while allowing all other vehicle features. Various possibilities can be provided in different embodiments depending upon which operations are considered most distracting.

During operation, some embodiments will allow the vehicle features contained in the focus mode to be varied. For example, in some embodiments a user can select some or all of the features that will be included in the focus mode. In other embodiments, the system can keep track of which vehicle features tend to create more distractions in general or for a particular driver, and remove those from the focus mode. For example, if manipulation of a mobile phone is a common cause of distraction (i.e., mobile phone use often has a cognitive load higher than its respective cognitive load threshold), then access to the mobile phone circuit may be taken out of the focus mode. Likewise, if streaming video does not often cause distraction (i.e., streaming video often has a cognitive load lower than its respective cognitive load threshold), then streaming video access may be placed in the focus mode or even returned to the focus mode after initially being removed. Such changes in the focus mode can dynamically occur throughout operation.

In addition, the vehicle features contained in the focus mode may vary from driver to driver. In this case, the system would use a method of identification such as facial recognition, voice recognition, a requirement to login for each individual driver, or the like. Once a driver is identified, a custom focus mode could then be used for that driver. Typically, a default focus mode would be used if the driver could not be identified.

Furthermore, some vehicle features would be guaranteed to be in the focus mode regardless of distraction levels because of their importance. For example, HVAC operations and navigation operations may be considered essential operations and guaranteed to be in the focus mode, even if the user might want to remove them, or they proved to be a common cause of driver distraction. More or fewer operations may be considered essential in other embodiments. However, because they represent potential sources of distraction, they are still considered for the purposes of predicting whether the driver is distracted.

Also, different kinds of operations may impose different focus modes, with focus modes changing dynamically as the kind of operation changes. For example, a driver distraction mitigation system used in a ridesharing vehicle might require a more stringent focus mode when passengers are in the car, or it might even require moving to the focus mode regardless of cognitive load when passengers are in the car. Such a system might allow for a less restrictive focus mode or no focus mode at all when there are no passengers in the car. In addition, there may be a security mode in some embodiments that will limit the ability of a user or the system to make changes to the vehicle features contained in the focus mode or omitted from the focus mode without authorization. For example, a ridesharing organization might limit its driver's ability to modify the focus mode during ridesharing operations.

Furthermore, in some embodiments, the system may offer suggestions to minimize distraction when moving it to the focus mode or even at step before the focus mode is required but in which a cognitive load is close to the cognitive load threshold. These suggestions could be provided on a visual display or broadcast as spoken word via a speaker. For example, these suggestions could include a recommendation to pull over and take a rest, a recommendation to play quiet music, a recommendation to go to a nearby coffee shop to purchase coffee along with an indication of the navigational route to the nearest coffee shop, etc. In some embodiments, some of the changes could be implemented automatically rather than being made as suggestions. For example, in one embodiment the system could replace loud music with quieter music automatically when entering a focus mode.

If, however, the cognitive load was determined to not be greater than the threshold (1150, path labeled N), the system will disable the focus mode of vehicle operation. (1180) If the focus mode of vehicle operation was already disabled, the system will simply maintain the disabling of the focus mode of vehicle operation. After disabling the focus mode of vehicle operation, the system will then enable the standard mode of vehicle operation, allowing greater or full access to vehicle features. (1190) If the standard mode of vehicle operation was already enabled, the system will simply maintain the enablement of the standard motor vehicle operation.

Operation then returns to monitoring the interior and exterior of vehicle using a plurality of vehicle sensors. (1120)

In alternate embodiments, the system can also be controlled by voice. In such embodiments, a voice assistant can be provided that can inform the user about their distraction level and suggest possible solutions. The user can interact with the vehicle/driver to either engage the focus mode or ask for suggestions to tackle possible distractions, drowsiness, tiredness, etc. In such case, the driver could manually enter the focus mode by making a request to the voice assistant.

In addition, although the disclosed embodiments provide only two modes of operation: a focus mode and a standard mode, alternate embodiments could provide multiple focus modes, each getting progressively more restrictive by limiting the driver to fewer features at each step. The system could then step up and down between a standard mode of operation and a most restrictive focus mode, passing between one or more intermediate focus modes, based on the amount of detected driver distraction.

### Gathering Vehicle Sensor Data

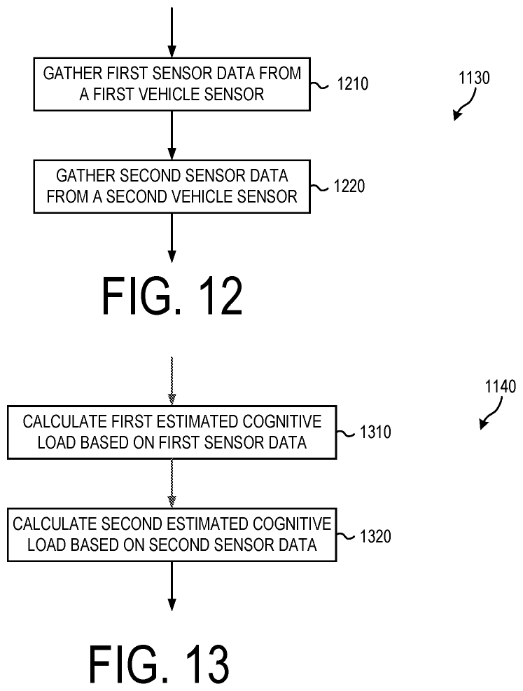

FIG. 12 is a flow chart of the operation of gathering vehicle sensor data 1130 of FIG. 11 according to disclosed embodiments.

As shown in FIG. 12, the operation of gathering vehicle sensor data 1130 begins by gathering first sensor data from a first vehicle sensor. (1210) Operation then continues by gathering second sensor data from a second vehicle sensor. (1220) The first and second vehicle sensors are typically different sensors but may be the same type of sensor or may be different types of sensors in alternate embodiments. It is possible in some embodiments that the first and second vehicle sensors are the same sensor, provided that it gathers different sensor data about different potential distractions. For example, a DMS RGB camera might gather first sensor data about drowsiness and second sensor data about driver gaze.

Although FIG. 12 only shows gathering first and second sensor data, alternate embodiments could increase the number of sets of sensor data that are obtained up to and including the total number of sensors provided in the driver distraction mitigation system.

In some embodiments at least one of the first sensor data or second sensor data must be one of visual image data or audio data. The other of the first and second sensor data can be from any type of sensor.

### Estimating Cognitive Load

FIG. 13 is a flow chart of the operation of estimating cognitive load 1140 of FIG. 11 according to disclosed embodiments.

As shown in FIG. 13, the operation of estimating cognitive load 1140 begins by calculating a first estimated cognitive data load based on first sensor data. (1310) The first sensor data is the sort of sensor data that can be used to predict cognitive load for a first possible distraction. For example, the first sensor data could be image data of a driver's face for determining a cognitive load for drowsiness. Likewise, the first sensor data could be audio data from the interior of the vehicle for determining a cognitive load for passenger noise distraction. Multiple other types of sensor data can be used for different types of possible distraction.

The calculation of the first estimated cognitive load can be achieved by reading a current first cognitive load from a memory and adding a first increasing incremental amount if a triggering event has occurred in the current timeframe, or subtracting a first decreasing incremental amount if a triggering event has not occurred in the current timeframe. Alternate embodiments could include a different category during which no change is made to the first cognitive load. The first increasing incremental amount and the first decreasing incremental amount may be the same or different.

The operation of estimating cognitive load 1140 continues by calculating a second estimated cognitive data load based on second sensor data. (1320) The second sensor data is the sort of sensor data that can be used to predict cognitive load for a second possible distraction, with the. For example, the second sensor data could be image data of a driver's face for determining a cognitive load for whether the driver's gaze is focused on the road. Likewise, the second sensor data could be HMI data from an HMI circuit for determining a cognitive load for an HMI distraction event. Multiple other types of sensor data can be used for different types of possible distraction.

The calculation of the second estimated cognitive load can be achieved by reading a current second first cognitive load from a memory and adding a second increasing incremental amount if a relevant triggering event has occurred in the current timeframe, or subtracting a second decreasing incremental amount if the relevant triggering event has not occurred in the current timeframe. Alternate embodiments could include a different category during which no change is made to the first cognitive load. The second increasing incremental amount and the second decreasing incremental amount may be the same or different.

Determining if Cognitive Load is Greater than a Threshold Cognitive Load

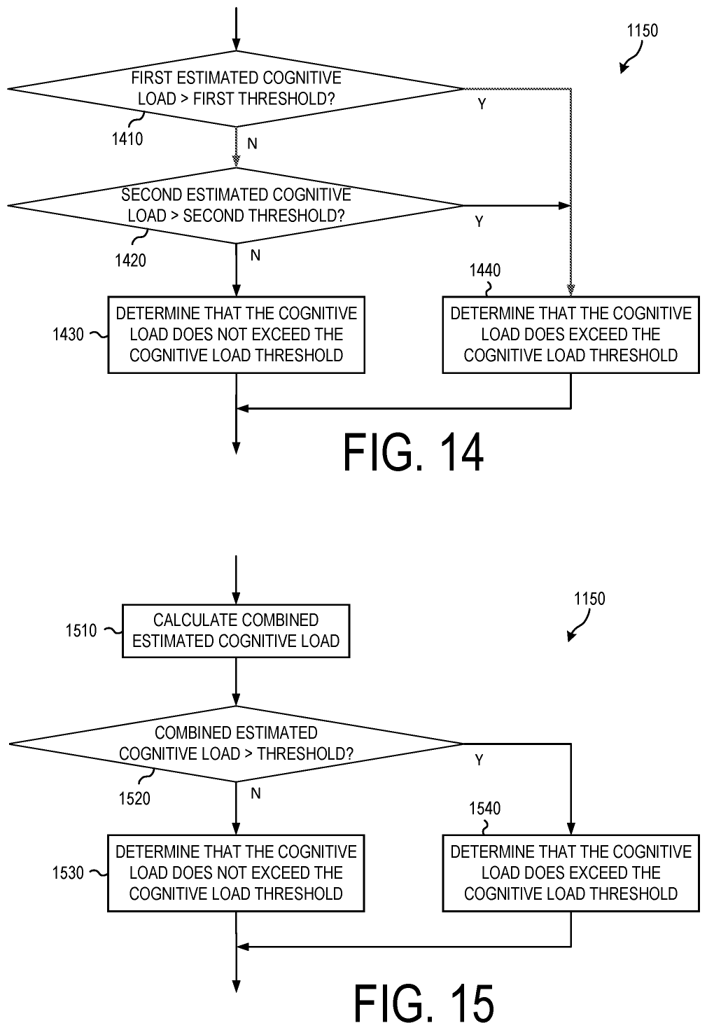

FIG. 14 is a flow chart of the operation of determining if cognitive load is greater than a threshold cognitive load 1150 of FIG. 11 according to first disclosed embodiments. These first disclosed embodiments involve checking multiple cognitive loads individually.

As shown in FIG. 14, the operation 1150 begins by determining whether a first estimated cognitive load is greater than a first cognitive load threshold (1410), and then determining whether the second estimated cognitive load is greater than a second cognitive load threshold. (1420) The first and second cognitive load thresholds may be the same or different in various embodiments.

If both the first estimated cognitive load is not greater than the first cognitive load threshold (1410, N branch) and the second estimated cognitive load is not greater than the second cognitive load threshold (1420, Y branch), then the system determines that the overall cognitive load does not exceed the overall cognitive load threshold. (1430)

If, however, either the first estimated cognitive load is greater than the first cognitive load threshold (1410, Y branch) or the second estimated cognitive load is greater than the second cognitive load threshold (1420, Y branch), then the system determines that the overall cognitive load does exceed the overall cognitive load threshold. (1440)

FIG. 15 is a flow chart of the operation of determining if cognitive load is greater than a threshold cognitive load 1150 of FIG. 11 according to second disclosed embodiments. These second disclosed embodiments involve checking multiple cognitive loads collectively.

As shown in FIG. 15, the operation 1150 begins by calculating a combined estimated cognitive load. (1510) This can be achieved by either averaging a first and second cognitive loads without weighting, or by averaging the first and second cognitive loads using weighting. In such case each of the first and second cognitive loads will be multiplied by a weighting factor prior to being added together and divided by two.

The operation 1150 continues by determining whether the combined estimated cognitive load is greater than a combined cognitive load threshold. (1520).

If the combined estimated cognitive load is not greater than the combined cognitive load threshold (1520, N branch), then the system determines that the overall cognitive load does not exceed the overall cognitive load threshold. (1530)

If, however, the combined estimated cognitive load is greater than the combined cognitive load threshold (1520, Y branch) (1420, Y branch), then the system determines that the overall cognitive load does exceed the overall cognitive load threshold. (1540)

Although FIGS. 14 and 15 disclose embodiments in which the cognitive loads are checked either individually or collectively, a hybrid of these two can be performed in alternate embodiments. In such case the operation could look to see if either one of any individual estimated cognitive load a respective individual cognitive load was above threshold or if a collective cognitive load was above a collective cognitive load threshold. The cognitive load thresholds can be the same or different for these operations. For example, in one embodiment the collective cognitive load threshold could be lower than the individual cognitive load thresholds.

### CONCLUSION

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

1. A computer-implemented method of mitigating driver distraction in a vehicle, the method comprising:
enabling a first mode in which a first plurality of vehicle features are configured to be controllable by a driver or passenger;
monitoring an interior of the vehicle using a plurality of vehicle sensors;
gathering vehicle sensor data from the plurality of vehicle sensors;
estimating a cognitive load of the driver based on the vehicle sensor data;
determining that the cognitive load of the driver exceeds a cognitive load threshold;
disabling the first mode and enabling a focus mode in response to determining that the cognitive load of the driver exceeds a cognitive load threshold, the focus mode disabling one or more vehicle features from the first plurality of vehicle features and enabling a second plurality of vehicle features to be controlled by the driver or passenger, the second plurality of vehicle features being a subset of the first plurality of vehicle features that is smaller in number than the first plurality of vehicle features.

2. The method of mitigating driver distraction in the vehicle of claim 1, wherein the estimating of the cognitive load of the driver based on the vehicle sensor data further includes:
gathering first sensor data from a first vehicle sensor;
gathering second sensor data from a second vehicle sensor;
calculating a first estimated cognitive load based on the first sensor data; and
calculating a second estimated cognitive load based on the second sensor data.

3. The method of mitigating driver distraction in the vehicle of claim 2, wherein the determining that the cognitive load of the driver exceeds the cognitive load threshold further includes:
determining that the first estimated cognitive load exceeds a first cognitive load threshold;
determining that the second estimated cognitive load does not exceed a second cognitive load threshold; and
determining that the cognitive load of the driver exceeds the cognitive load threshold based on the determination that the first estimated cognitive load exceeds the first cognitive load threshold.

4. The method of mitigating driver distraction in the vehicle of claim 2, wherein the determining that the cognitive load of the driver exceeds the cognitive load threshold further includes:
calculating a combined estimated cognitive load based on both the first estimated cognitive load and the second estimated cognitive load; and
determining that the combined estimated cognitive load exceeds a combined cognitive load threshold; and
determining that the cognitive load of the driver exceeds the cognitive load threshold based on the determination that the combined estimated cognitive load exceeds the combined cognitive load threshold.

5. The method of mitigating driver distraction in the vehicle of claim 4, wherein in calculating the combined estimated cognitive load based on both the first estimated cognitive load and the second estimated cognitive load, the first estimated cognitive load and the second estimated cognitive load are given different weights.

6. The method of mitigating driver distraction in the vehicle of claim 1, wherein
the subset of the first plurality of vehicle features that forms the second plurality of vehicle features are modified based on previous vehicle sensor data from the plurality of vehicle sensors and related determinations regarding a driver status of the driver and an environmental status of the interior of the vehicle.

7. The method of mitigating driver distraction in the vehicle of claim 1, wherein
the subset of the first plurality of vehicle features that forms the second plurality of vehicle features are configured to be modifiable based on input from the driver.

8. The method of mitigating driver distraction in the vehicle of claim 1, wherein
a selection of the plurality of vehicle sensors from a number of available vehicle sensors are configured to be modifiable based on input from the driver.

9. The method of mitigating driver distraction in the vehicle of claim 1, wherein
a selection of possible distractions monitored by the plurality of vehicle sensors are configured to be modifiable based on input from the driver.

10. The method of mitigating driver distraction in the vehicle of claim 1, further comprising
identifying one or more mitigating activities in response to determining that the cognitive load of the driver exceeds the cognitive load threshold, the one or more mitigating activities being predicted to reduce distraction of the driver;
announcing the one or more mitigating activities to the driver.

11. The method of mitigating driver distraction in the vehicle of claim 1, wherein the operation of determining that the cognitive load of the driver exceeds the cognitive load threshold further comprises:
receiving a voice command from the driver indicating that the cognitive load of the driver exceeds the cognitive load threshold.

12. A non-transitory computer-readable medium comprising instructions for execution by a computer, the instructions including a computer-implemented method for mitigating driver distraction in a vehicle, the instructions for implementing:
enabling a first mode in which a first plurality of vehicle features are configured to be controllable by a driver or passenger;
monitoring an interior of the vehicle using a plurality of vehicle sensors;
gathering vehicle sensor data from the plurality of vehicle sensors;
estimating a cognitive load of the driver based on the vehicle sensor data;
determining that the cognitive load of the driver exceeds a cognitive load threshold; and
disabling the first mode and enabling a focus mode in response to determining that the cognitive load of the driver exceeds a cognitive load threshold, the focus mode disabling one or more vehicle features from the first plurality of vehicle features and enabling a second plurality of vehicle features to be controlled by the driver or passenger, the second plurality of vehicle features being a subset of the first plurality of vehicle features that is smaller in number than the first plurality of vehicle features.

13. The non-transitory computer-readable medium, as recited in claim 12, wherein the estimating of the cognitive load of the driver based on the vehicle sensor data further includes:
gathering first sensor data from a first vehicle sensor;
gathering second sensor data from a second vehicle sensor;
calculating a first estimated cognitive load based on the first sensor data; and
calculating a second estimated cognitive load based on the second sensor data.

14. The non-transitory computer-readable medium, as recited in claim 13, wherein the determining that the cognitive load of the driver exceeds the cognitive load threshold further includes:
determining that the first estimated cognitive load exceeds a first cognitive load threshold;
determining that the second estimated cognitive load does not exceed a second cognitive load threshold; and
determining that the cognitive load of the driver exceeds the cognitive load threshold based on the determination that the first estimated cognitive load exceeds the first cognitive load threshold.

15. The non-transitory computer-readable medium, as recited in claim 13, wherein the determining that the cognitive load of the driver exceeds the cognitive load threshold further includes:
calculating a combined estimated cognitive load based on both the first estimated cognitive load and the second estimated cognitive load; and
determining that the combined estimated cognitive load exceeds a combined cognitive load threshold; and
determining that the cognitive load of the driver exceeds the cognitive load threshold based on the determination that the combined estimated cognitive load exceeds the combined cognitive load threshold.

16. The non-transitory computer-readable medium, as recited in claim 15, wherein in calculating the combined estimated cognitive load based on both the first estimated cognitive load and the second estimated cognitive load, the first estimated cognitive load and the second estimated cognitive load are given different weights.

17. A computer system configured for controlling an operational mode of an outdoor air-conditioning unit connected to a plurality of indoor air-conditioning units, the plurality of indoor air-conditioning units including a master indoor unit and a plurality of reporting indoor units, the system comprising:
a transceiver operable to transmit and receive communications over at least a portion of a network;
a memory configured to store data and instructions; and
a processor cooperatively operable with the transceiver and the memory, and configured to facilitate:
enabling a first mode in which a first plurality of vehicle features are configured to be controllable by a driver or passenger;
monitoring an interior of the vehicle using a plurality of vehicle sensors;
gathering vehicle sensor data from the plurality of vehicle sensors;
estimating a cognitive load of the driver based on the vehicle sensor data;
determining that the cognitive load of the driver exceeds a cognitive load threshold; and
disabling the first mode and enabling a focus mode in response to determining that the cognitive load of the driver exceeds a cognitive load threshold, the focus mode disabling one or more vehicle features from the first plurality of vehicle features and enabling a second plurality of vehicle features to be controlled by the driver or passenger, the second plurality of vehicle features being a subset of the first plurality of vehicle features that is smaller in number than the first plurality of vehicle features.

18. The computer system, as recited in claim 17, wherein the estimating of the cognitive load of the driver based on the vehicle sensor data further includes:
gathering first sensor data from a first vehicle sensor;
gathering second sensor data from a second vehicle sensor;
calculating a first estimated cognitive load based on the first sensor data; and
calculating a second estimated cognitive load based on the second sensor data.

19. The computer system, as recited in claim 18, wherein the determining that the cognitive load of the driver exceeds the cognitive load threshold further includes:
determining that the first estimated cognitive load exceeds a first cognitive load threshold;
determining that the second estimated cognitive load does not exceed a second cognitive load threshold; and
determining that the cognitive load of the driver exceeds the cognitive load threshold based on the determination that the first estimated cognitive load exceeds the first cognitive load threshold.

20. The computer system, as recited in claim 18, wherein the determining that the cognitive load of the driver exceeds the cognitive load threshold further includes:
calculating a combined estimated cognitive load based on both the first estimated cognitive load and the second estimated cognitive load; and
determining that the combined estimated cognitive load exceeds a combined cognitive load threshold; and
determining that the cognitive load of the driver exceeds the cognitive load threshold based on the determination that the combined estimated cognitive load exceeds the combined cognitive load threshold.
